(19) United States
(12) Patent Application Publication
(10) Pub. No.: US 2012/0241021 A1
(43) Pub. Date: Sep. 27, 2012

(54) COUPLING WITH SECONDARY VALVE STOP

(75) Inventor: LEONARD J. NICK, LUCINDA, PA (US)

(73) Assignee: SNAP-TITE TECHNOLOGIES, INC., WILMINGTON, DE (US)

(21) Appl. No.: 13/052,520

(22) Filed: Mar. 21, 2011

(51) Int. Cl. F16K 51/00

(52) U.S. Cl. 137/343; 137/614.06

(57) ABSTRACT

The male coupling half includes a body, an adaptor, a main valve, a secondary valve, and a secondary valve stop. The secondary valve stop is affixed to the secondary valve. The secondary valve stop resides intermediate the main valve and the adaptor. The main valve in combination with the secondary valve stop limit movement of the secondary valve preventing over travel of the secondary valve.

### FIELD OF THE INVENTION

The invention is in the field of couplings.

### BACKGROUND OF THE INVENTION

Known devices employ secondary valves that experience over travel and extend into the flow stream too far thus reducing the flow capacity of the coupling. Additionally, there are problems with springs which are compressed and fatigued thus losing their ability to return the components of the coupling to their original positions which are necessary to prevent leakage and other undesirable characteristics.

### SUMMARY OF THE INVENTION

The male coupling half is generally coupled with a female coupling half. The male coupling half includes structure to reduce the pressure behind a secondary valve.

The male coupling half includes a body, an adaptor, a main valve, a secondary valve, and a secondary valve stop. The secondary valve stop is affixed to the secondary valve. The secondary valve stop resides intermediate the main valve and the adaptor. The main valve in combination with the secondary valve stop limit movement of the secondary valve preventing over travel of the secondary valve.

Referring to the male coupling half, the secondary valve stop is generally cylindrically shaped. The generally cylindrically shaped secondary valve stop includes an end portion having a yoke. The secondary valve includes a shoulder thereon and a circumferential groove therein which enable securement of the secondary valve to the secondary valve stop member. The yoke portion abuts the shoulder of the secondary valve and the yoke portion of the secondary valve stop includes the first and second pin holes therein. First and second pins extend through first and second pin holes in the yoke portion and interengage the circumferential groove of the secondary valve to prevent axial movement of the secondary valve with respect to the secondary valve support. The secondary valve stop further includes a snap ring groove, and, the snap ring groove traverses the first and second pin holes and secures the pins in place and against outward radial movement.

Referring to the male coupling half, a snap ring or other retaining member resides in the snap ring groove retaining the first and second pins. The secondary valve stop is capable or rotation about the secondary valve. A secondary valve stop engagement surface abuts the male adaptor and prevents over travel of the secondary valve.

Referring to the male half of the coupling, in a first example or embodiment the secondary valve stop does not extend past the main valve when fully coupled with no flow in the coupling. Put another way, when the secondary valve stop engages the main valve with the coupling halves fully connected and no flow is in the coupling, the secondary valve stop does not extend past the main valve. The first example or embodiment is subject to flow conditions within the coupling when fully connected. The first flow condition is when there is no flow through the male and female coupling halves. The second flow condition is from the male coupling half to the female coupling half. The flow conditions within the coupling affect the position of the main valve, the secondary valve and secondary valve stop. The main valve resides within the body and is movable during coupling between: a first, closed position wherein the main valve engages the body; and a second, open position wherein the main valve is spaced apart from the adaptor when fully coupled under the aforestated flow conditions. The secondary valve stop is movable during coupling between a first position spaced apart from the main valve and a second position engaging the main valve and spaced apart from the adaptor when fully coupled under the aforestated flow conditions. The secondary valve is movable during coupling between: a first, closed position; and, a second, open position when fully coupled under the aforestated flow conditions.

Still referring to the male coupling half and the first example/embodiment of the invention. In the first example the secondary valve stop does not extend past the main valve when fully coupled with no flow in the coupling as stated above. When flow is from the female coupling half to the male coupling half the positions of the main valve, the secondary valve and secondary valve stop are impacted. The main valve resides within the body and is movable during coupling between: a first, closed position wherein the main valve engages the body; and, a third, open position wherein the main valve engages the adaptor when fully coupled under the aforestated flow conditions. The secondary valve stop is movable during coupling between a first position spaced apart from the main valve and a third position spaced apart from the main valve and engaging the adaptor when fully coupled under the aforestated flow conditions. The secondary valve is movable during coupling between: a first, closed position; and, a third, open position when fully coupled under the aforestated flow conditions.

Still referring to the male coupling half, in a second example/embodiment of the invention, the secondary valve stop extends past the main valve when fully coupled and with no flow in the coupling. Put another way, when the secondary valve stop engages the main valve with the coupling halves fully connected and no flow in the coupling, the secondary valve stop extends past the main valve. The second example or embodiment is subject to flow conditions within the coupling when fully connected. The first flow condition is when there is no flow in the coupling when the coupling is fully coupled. The second flow condition is flow from the male half of the coupling to the female half of the coupling when the coupling is fully coupled. The flow condition within the coupling affects the position of the main valve, the secondary valve and secondary valve stop. Under these flow conditions, the main valve resides within the body and is movable during coupling between: a first, closed position wherein the main valve engages the body; and a second, open position wherein the main valve is spaced apart from the adaptor when fully coupled under the aforestated flow conditions. The secondary valve stop is movable during coupling between a first position spaced apart from the main valve and a second position engaging the main valve and spaced apart from the adaptor when fully coupled under the aforestated flow conditions. The secondary valve is movable during coupling between: a first, closed position; and, a second, open position when fully coupled under the aforestated flow conditions.

Still referring to the male coupling half and the second example/embodiment of the invention, the secondary valve stop extends past the main valve when fully coupled and with no flow in the coupling. When there is flow in the coupling from the female half of the coupling to the male half of the coupling when the coupling is fully coupled, the main valve resides within the body and is movable during coupling between: a first, closed position wherein the main valve engages the body; and a second, open position wherein the main valve is spaced apart from the adaptor when fully coupled under the aforestated flow conditions. The secondary valve stop is movable during coupling between a first position spaced apart from the main valve and a third position spaced apart from the main valve and engaging the adaptor when fully coupled under the aforestated flow conditions. The secondary valve is movable during coupling between: a first, closed position; and, a third open position when fully coupled under the aforestated flow conditions.

A coupling stem support member in combination with a stem is disclosed and claimed which includes a generally cylindrical housing. The generally cylindrical housing includes a cylindrical wall portion having an interior portion and an exterior portion. The generally cylindrical housing includes an end portion thereof. In turn, the end portion of the generally cylindrical housing includes a yoke portion. The yoke portion of the end portion of the generally cylindrical housing includes a web having a cross-member and a thicker portion integral with the generally cylindrical wall of the housing. The yoke portion of the generally cylindrical housing includes an axial bore therethrough for receiving the stem, the axial bore includes an inner diameter. The cross-member of the yoke includes first and second bores therein extending from the exterior portion of the wall portion of the housing to the axial bore of the yoke portion of the generally cylindrical housing. The stem being generally cylindrically shaped, the stem includes an outer diameter slightly smaller than the inner diameter of the axial bore of the yoke portion of the generally cylindrical housing. First and second pins for axially securing the stem with respect to the generally cylindrical housing are provided. The stem includes a circumferential groove therein for receiving the first and second pins extending through the first and second bores of the cross-member of the yoke. A retaining member for retaining the first and second pins, respectively, in the first and second bores of the cross-member of the yoke and also for retaining the first and second pins in the circumferential groove of the stem. The retaining member is a snap ring and it may take any form. The snap-ring shown herein is oriented vertically but there can be other orientations.

The yoke portion of the generally cylindrical housing includes flow ports therein enabling fluid communication through the support member. The generally cylindrical housing includes a second end portion thereof terminating in a surface, the surface designed to engage another portion of the coupling. The stem includes a shoulder thereon which abuts the web portion of the yoke portion of the generally cylindrical housing.

In another embodiment a single pin may be used for axially securing the stem with respect to the generally cylindrical housing. In this embodiment the stem includes a bore therethrough for receiving the pin extending through the first and second bores of the cross-member of the yoke. A retaining member for retaining the pin in the first and second bores of the cross-member of the yoke is also used in this embodiment.

It is an object of the invention to provide a coupling which prevents over travel of the secondary valve in the male coupling half.

It is an object of the invention to ensure that the secondary valve does not over travel and block the flow of fluid through the male coupling half.

It is an object of the invention to provide a secondary valve stop which acts cooperatively with a main valve (nipple valve) to prevent over travel of the secondary valve in the male coupling half.

It is an object of the invention to provide a coupling whose male half includes a secondary valve stop pinned to the secondary valve to prevent axial over travel of the secondary valve stop.

It is an object of the invention to protect springs used in the coupling half from being compressed thus losing their ability to function and to function properly.

It is an object of the invention to provide a robust coupling that maintains flow capacity under various operating flow conditions.

It is an object of the invention to provide a robust coupling stem support member which also acts to prevent over travel of the stem.

It is an object of the invention to provide a robust coupling stem support member which employs a cylindrically shaped housing member, pins and a snap ring to affix the housing member to the stem.

These and other objects of the invention will be best understood when reference is made to the drawings and the description of the invention which is set forth hereinbelow.

### BRIEF DESCRIPTION OF THE DRAWINGS

FIG. 1 is a front elevation view of the female coupling half.

FIG. 1A is a cross-sectional view of the female coupling half taken along the lines 1A-1A of FIG. 1.

FIG. 2 is a front elevation view of the male coupling half.

FIG. 2A is a cross-sectional view of the male coupling half taken along the lines 2A-2A of FIG. 1.

FIG. 3 is a front elevation view of the male and female halves of the coupling partially coupled wherein initial contact of the coupler and nipple half is occurring and the nipple valve is closed.

FIG. 3A is a cross-sectional view of the male and female halves of the coupling taken along the lines 3A-3A of FIG. 3 illustrating initial contact of the coupler and nipple half while the nipple valve is closed.

FIG. 4 is a front elevation view of the male and female halves of the coupling partially coupled wherein the nipple valve 31 initially contacts the bleeder valve with the bleeder valve closed.

FIG. 4A is a cross-sectional view of the male and female halves of the coupling partially coupled taken along the lines 4A-4A of FIG. 4 illustrating the nipple valve initially contacting the bleeder valve with the bleeder valve closed.

FIG. 5 is an elevation view of the male and female halves of the coupling partially coupled wherein the bleeder valve is open and the nipple valve and the secondary valve stop are making initial contact.

FIG. 5A is a cross-sectional view of the male and female halves of the coupling partially coupled taken along the lines 5A-5A of FIG. 5 wherein the bleeder valve is open and the nipple valve initially engages the secondary valve stop.

FIG. 5B is enlargement of a portion of FIG. 5A.

FIG. 6 is an elevation view of the coupling of the first example fully connected with no flow between the coupling halves or with flow from the male half to the female half and wherein the nipple valve (main valve) and the secondary valve stop are spaced apart from the nipple adaptor.

FIG. 6A is a cross-sectional view of the coupling of the first example fully connected taken along the lines 6A-6A of FIG. 6 with no flow between the coupling halves or with flow from the male half to the female half and wherein the nipple valve (main valve) and the secondary valve stop are spaced apart from the nipple adaptor.

FIG. 6B is an enlargement of a portion of FIG. 6A.

FIG. 6C is an enlargement of a portion of FIG. 6B

FIG. 6D is a cross-sectional view taken along the lines 6D-6D of FIG. 6A.

FIG. 6E is an enlargement of a portion of FIG. 6D.

FIG. 6F is a cross-sectional view of the example of FIG. 6A with the coupler fully connected under different flow conditions with flow from the female half to the male half and with the nipple valve (main valve) and the secondary valve stop engaging the nipple adaptor.

FIG. 6G is an enlargement of a portion of FIG. 6F.

FIG. 6H is a perspective view of the secondary valve stop.

FIG. 6I is a cross-sectional view of a second example of the coupling fully connected with no flow between the coupling halves or with flow from the male half to the female half and wherein the nipple valve (main valve) and the secondary valve stop are spaced apart from the nipple adaptor.

FIG. 6J is a cross-sectional view of a portion of FIG. 6I.

FIG. 6K is a cross-sectional view of a second example of the coupling fully connected with flow from the female half to the male half and with the nipple valve (main valve) spaced apart from the nipple adaptor and the secondary valve stop engaging the nipple adaptor.

FIG. 6L is an enlargement of a portion of FIG. 6K.

FIG. 7 is an elevation view of the secondary valve stop, the secondary valve and the bleeder stem.

FIG. 7A is an exploded view of the secondary valve stop, the secondary valve, the bleeder stem, the bleeder and the valve arrangement.

FIG. 7B is another example of the secondary valve illustrating slots in the secondary valve instead of a circumferential groove therein.

FIG. 8 is a cross-sectional view of a second embodiment of a valve stop without a snap ring.

FIG. 8A is a cross-sectional view taken along the lines 8A-8A of FIG. 8.

FIG. 9 is a cross-sectional view of a third embodiment of a valve stop without a snap ring and with a pin extending through the valve stop and through the secondary valve.

FIG. 9A is a cross-sectional view taken along the liens 9A-9A of FIG. 9.

FIG. 10 is a cross-sectional view of a fourth embodiment of a valve stop with a snap ring and a pin that extends through the valve stop and the secondary valve.

FIG. 10A is a cross-sectional view taken along the lines 10A-10A of FIG. 10.

### DESCRIPTION OF THE INVENTION

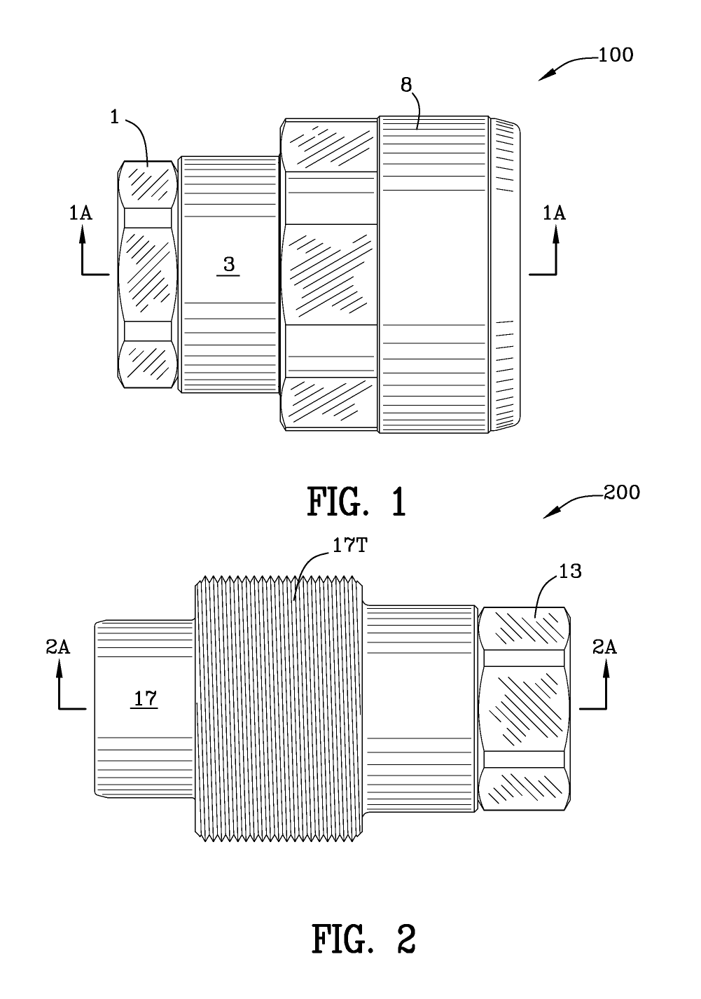

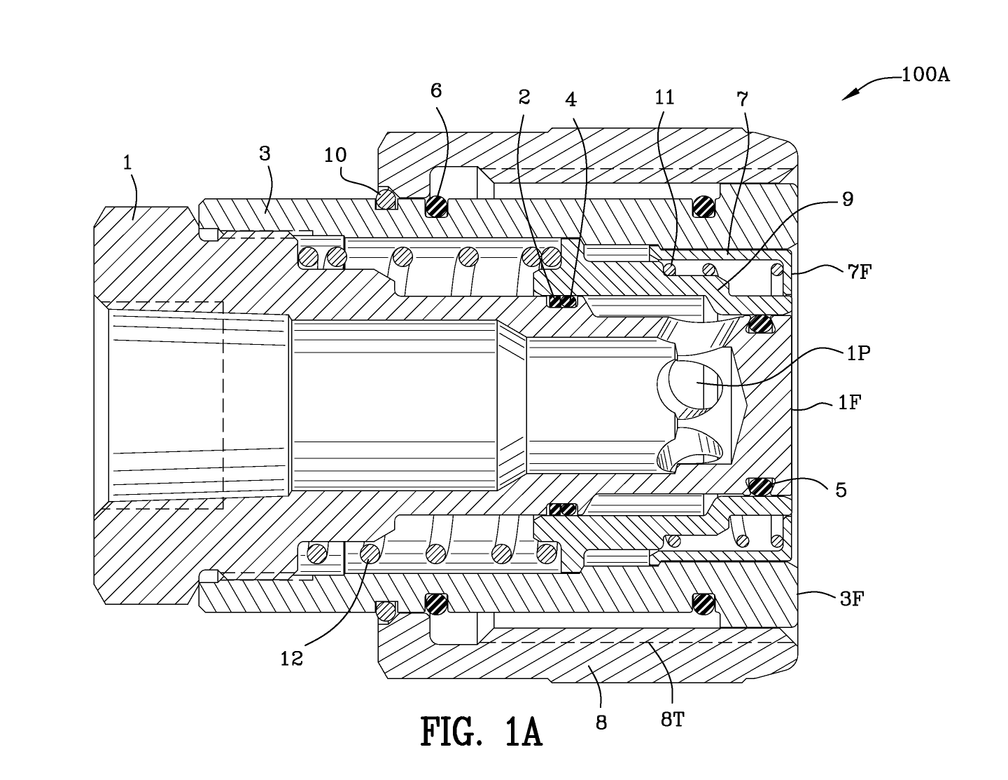

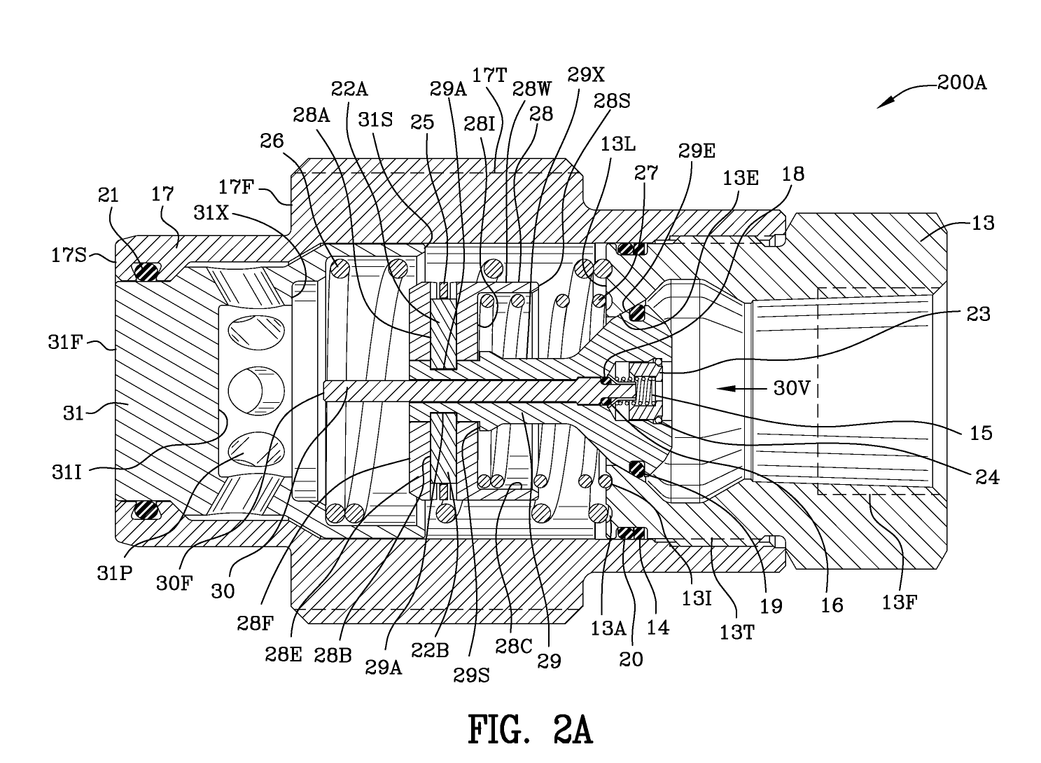

FIG. 1 is a front elevation view 100 of the female coupling half and FIG. 1A is a cross-sectional view 100A of the female coupling half taken along the lines 1A-1A of FIG. 1. FIG. 2 is a front elevation view 200 of the male coupling half and FIG. 2A is a cross-sectional view 200A of the male coupling half taken along the lines 2A-2A of FIG. 2.

FIG. 1 illustrates the female adaptor 1 and the female body 3 threaded to the female adaptor 1. Also illustrated in FIG. 1 is the sleeve 8 which includes internal threads 8T (not shown in this view) for connection with the male half of the coupling and the external threads 17T of male body 17 illustrated in FIG. 2. Referring to FIG. 2, male body 17, eternal threads 17T and adaptor 13 are illustrated.

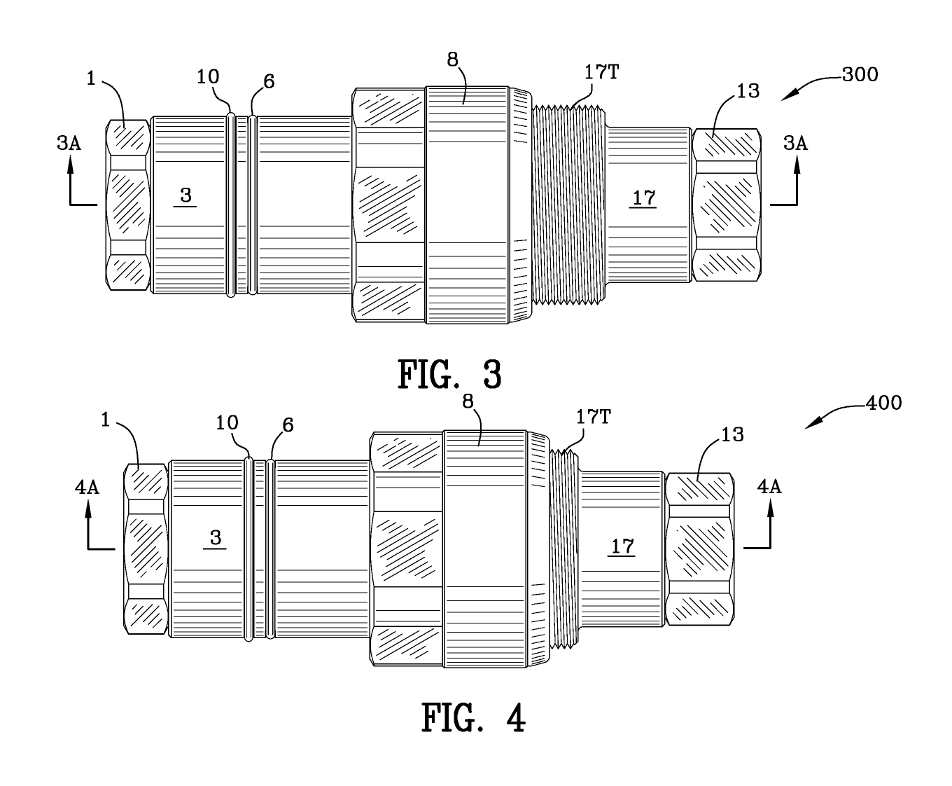

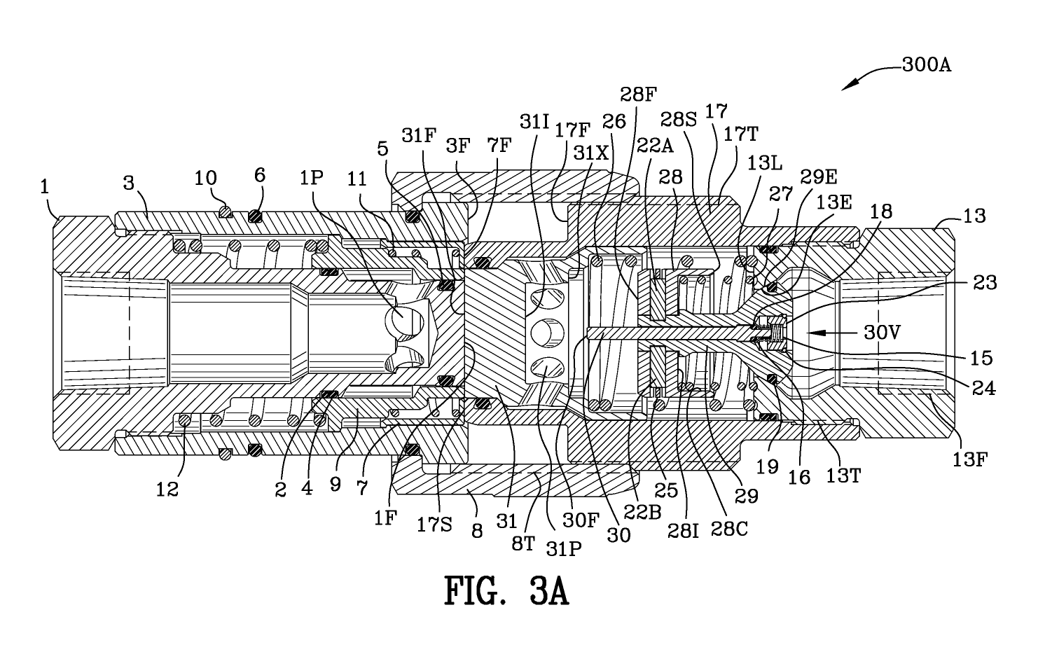

Referring to FIG. 1A, all of the components of the female coupling half are illustrated, including, the female adaptor 1, the female body 3, sliding sleeve 9, retainer 7, and sleeve 8 with threaded interior 8T. Various seals and seal components 2, 4, 5, 6, are illustrated in FIG. 1A. Flow ports 1P pass hydraulic fluid (or other fluid) therethrough when the female and male halves are coupled together. Snap ring 10 restrains sleeve 8 in one direction and does an unnumbered shoulder on body 3 in the other direction. Spring 12 is operable between a shoulder on adaptor 1 and sliding sleeve 9. Spring 11 is operable between sliding sleeve 9 and retainer 7. Retainer 7 has face 7F which correspondingly engages face 17S of male body 17 of the male coupling half. Adaptor 1 has face IF which correspondingly engages face 31F of main valve 31 of the male coupling half. Body 3 has face 3F which correspondingly engages face 17F of the male coupling half. See FIGS. 2A and 3A. FIG. 3A is a cross-sectional view 300 of the male and female halves of the coupling illustrating initial contact of the coupler (female) and nipple (male) half while the nipple valve (main valve) 31 is closed.

Referring to FIG. 2A, a cross-sectional view 200A of the male coupling half taken along the lines 2A-2A of FIG. 1, the components of the coupling are shown, namely, the main valve 31 (sometimes referred to herein as the nipple valve), the body 17, the adaptor 13, the secondary valve 29, and the valve stop 28. Reference numeral 17T is used to denote external threads on body 17 which interengage internal threads 8T on sleeve 8 of the female coupling half. Spring 26 is operable between adaptor 13 and an unnumbered interior shoulder of main valve 31. Spring 27 is operable between inner surface 28I and adaptor 13. Spring groove 13A in adaptor 13 supports spring 26 and spring groove 13I supports spring 27. Main valve 31 includes flow ports 31P, and inner surface 31I for engaging face 30F of bleeder valve 30, an interior shoulder 31X for engaging face 28F of the secondary valve stop 28, and an engaging surface 31S for engaging adaptor 13. Adaptor 13 includes lands 13L for engaging the engaging surface 31S of the main valve and the engaging surface 28S of the secondary valve stop 28. Reference numeral 13F indicates a threaded interconnection of the adaptor. Adaptor 13 is threaded 13T to body 17.

Secondary valve support 28 serves to protect springs 26 and 27 from being compressed beyond desired limits. For instance, if a spring is compressed to a solid stack it loses resiliency and therefore it loses its ability to function properly. A spring must maintain its resiliency to return the components of the coupling to their original or initial position in the uncoupled state. Additionally, the springs must maintain their spring rate for proper functioning of the coupling in the coupled and uncoupled condition.

Secondary valve 29 includes engagement valve surface 29E which interengages with adaptor valve surface 13E to prohibit fluid communication between adaptor 13 and the interior portion of body 17 of the male coupling half. Bleeder valve assembly 30V includes the bleeder valve 30, seal 18, brass eyelet 16, spring 15, retainer 23 and snap ring 24.

Secondary valve 29 further includes a bulbous portion having engagement valve surface 29E, a generally cylindrical bore therethrough for partially housing bleeder valve 30, and a generally cylindrical exterior having a shoulder 29S thereon. A notch or groove 29A extends circumferentially around the secondary valve. Notch or groove 29A interengages pins 22A, 22B which are used to affix secondary valve stop to secondary valve 29 against axial movement along the axis of secondary valve 29. Shoulder 29S also serves to restrict axial movement of secondary valve stop 28 with respect to secondary valve 29. Secondary valve stop 28 is affixed to secondary valve 29 and restricts its motion rightwardly when viewing FIGS. 2A, 3A, 4A, 5A, 6A, 6F, 6I, and 6K.

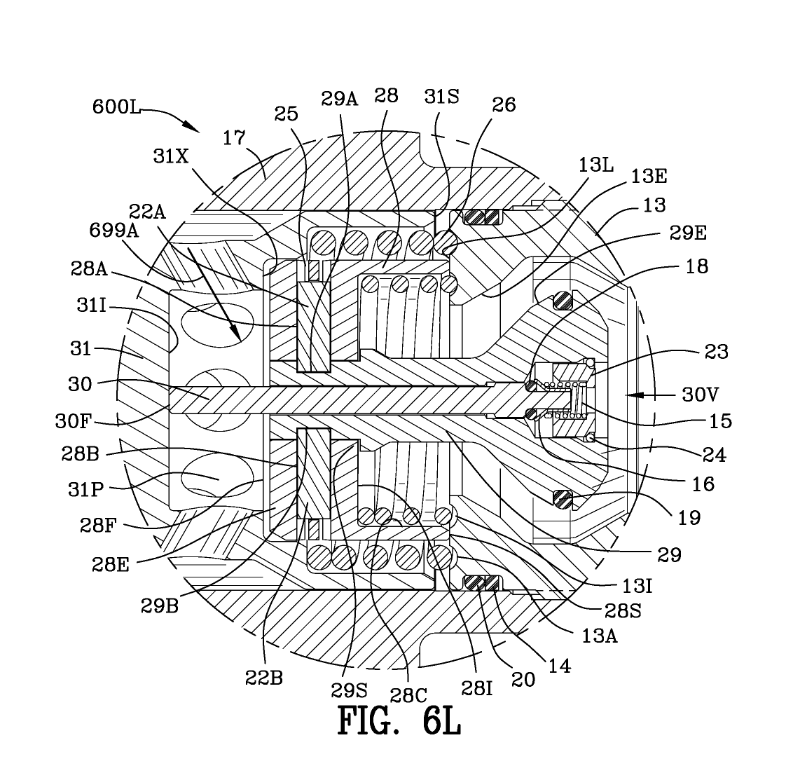

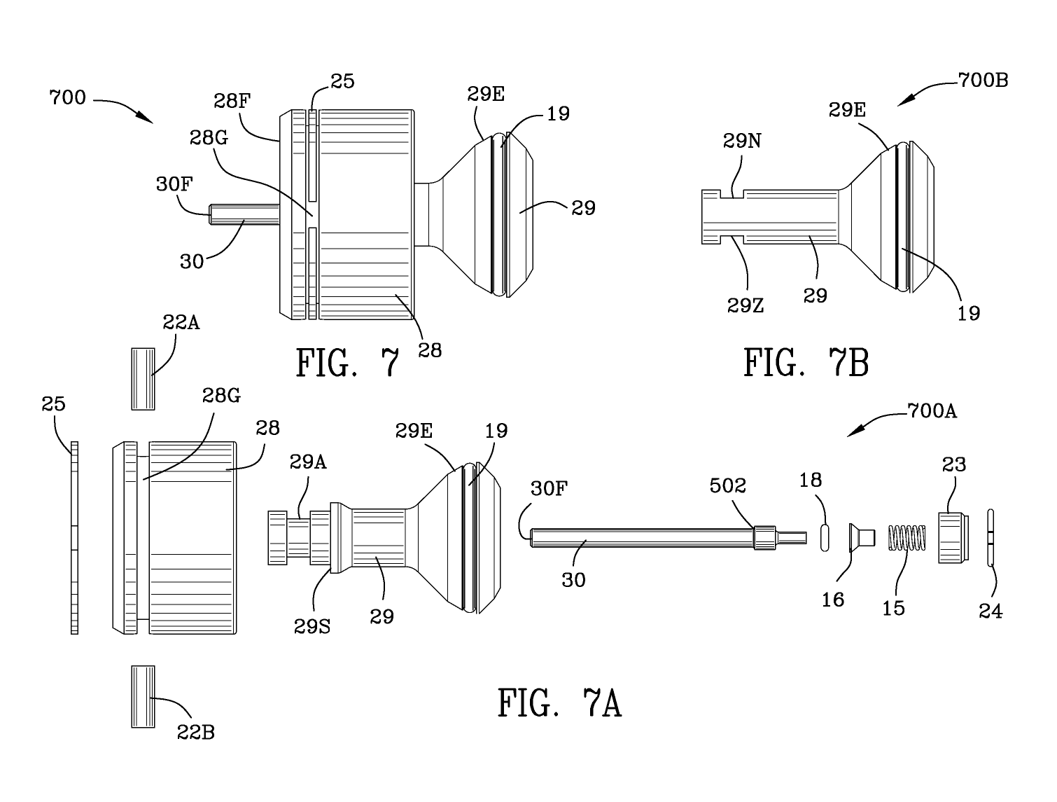

It is specifically contemplated herein that two slots in the exterior of secondary valve 29 may be used instead of a circumferentially extending notch or groove 29A. The slots would cut across arcs of the exterior of the secondary valve. If the arc is larger then each of the slots would be longer and deeper. See, FIG. 7B which is an illustration 700B of slots 29N and 29Z in another example of the secondary valve.

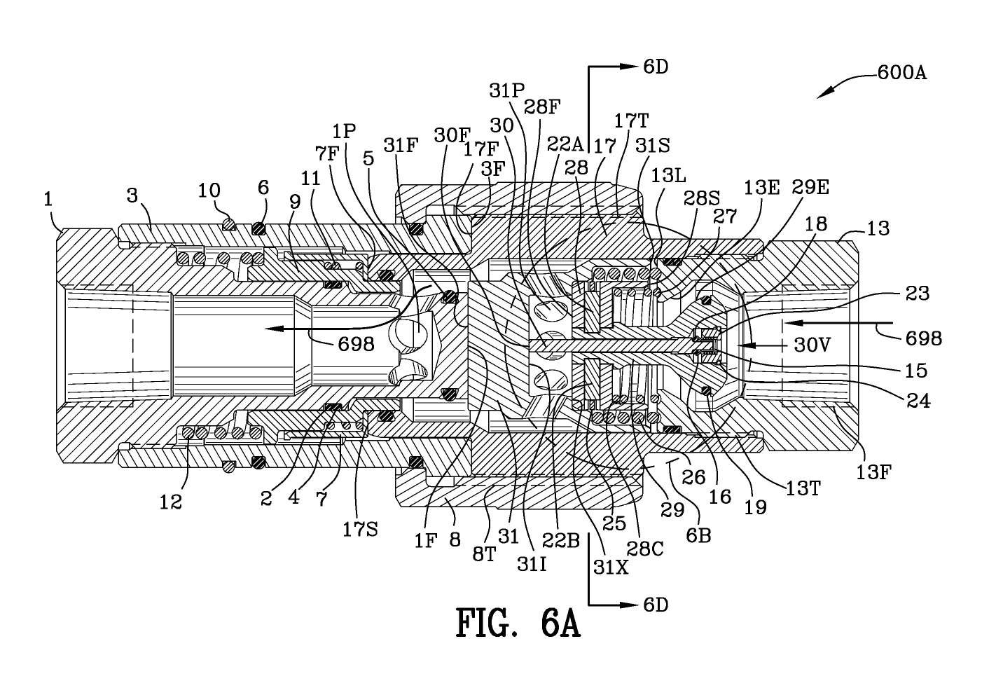

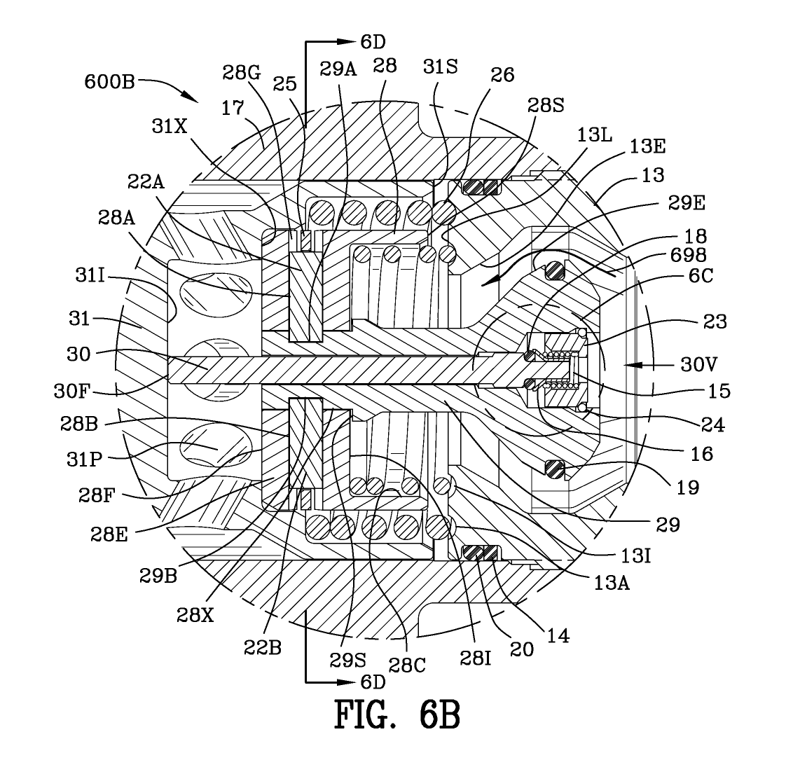

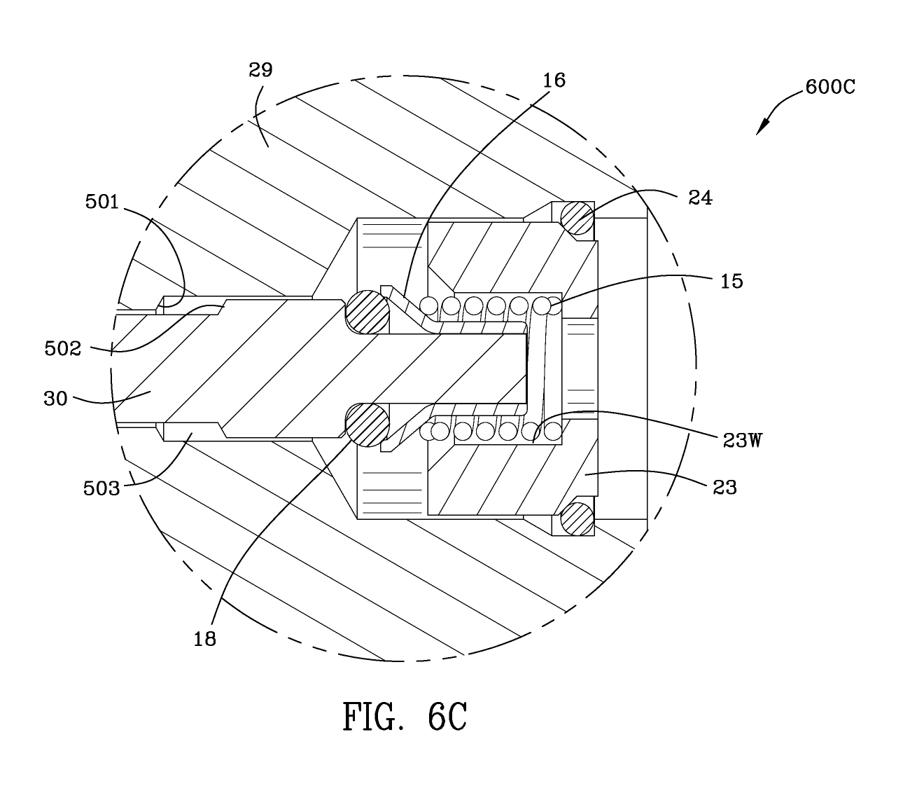

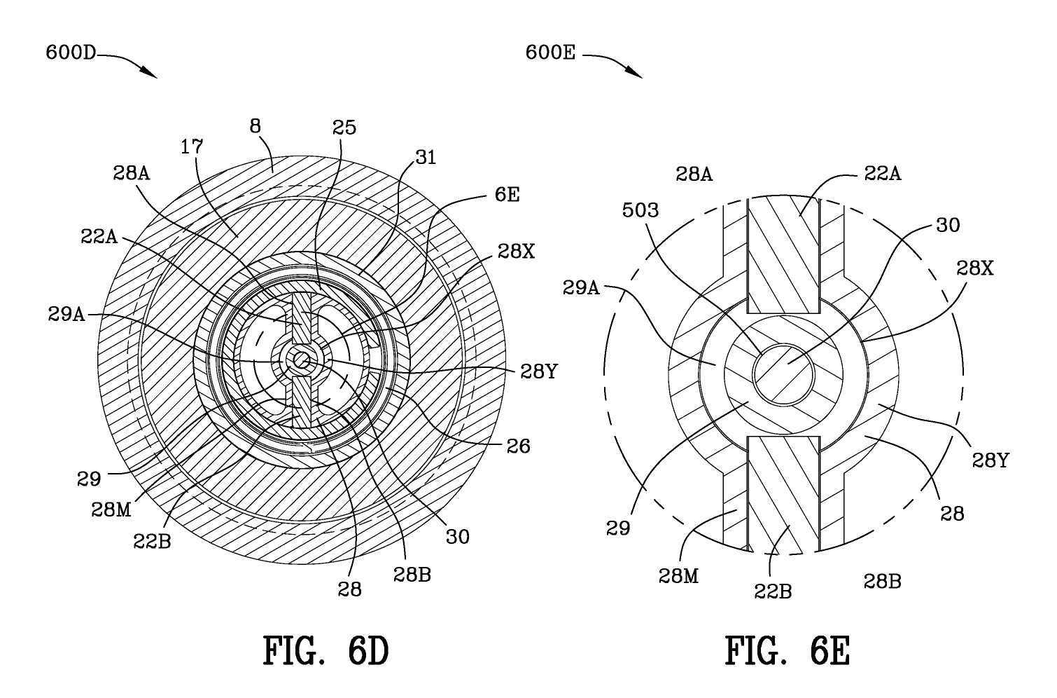

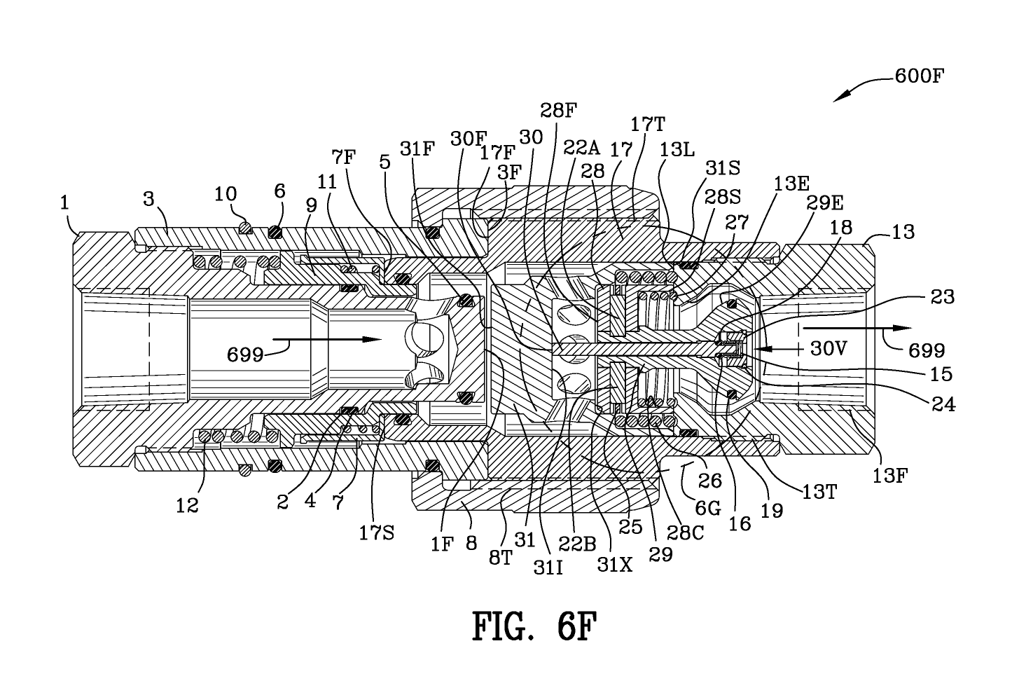

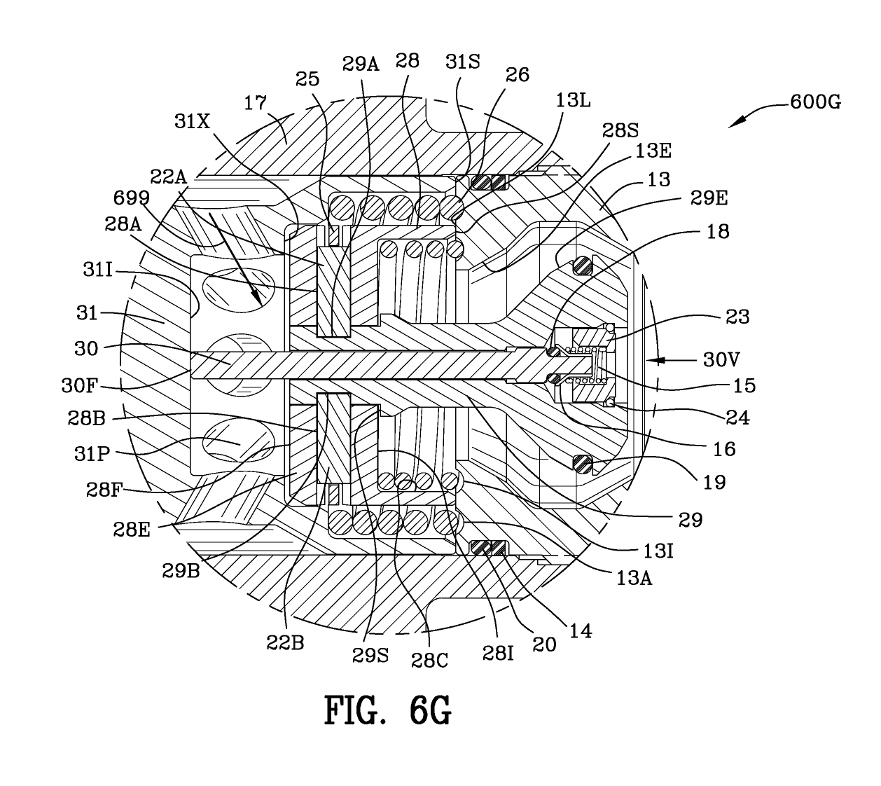

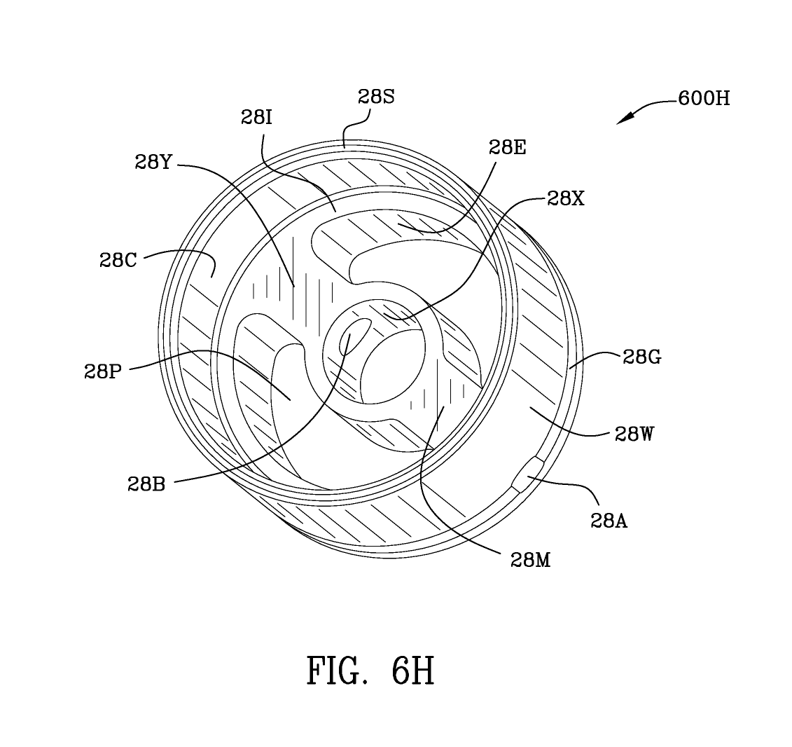

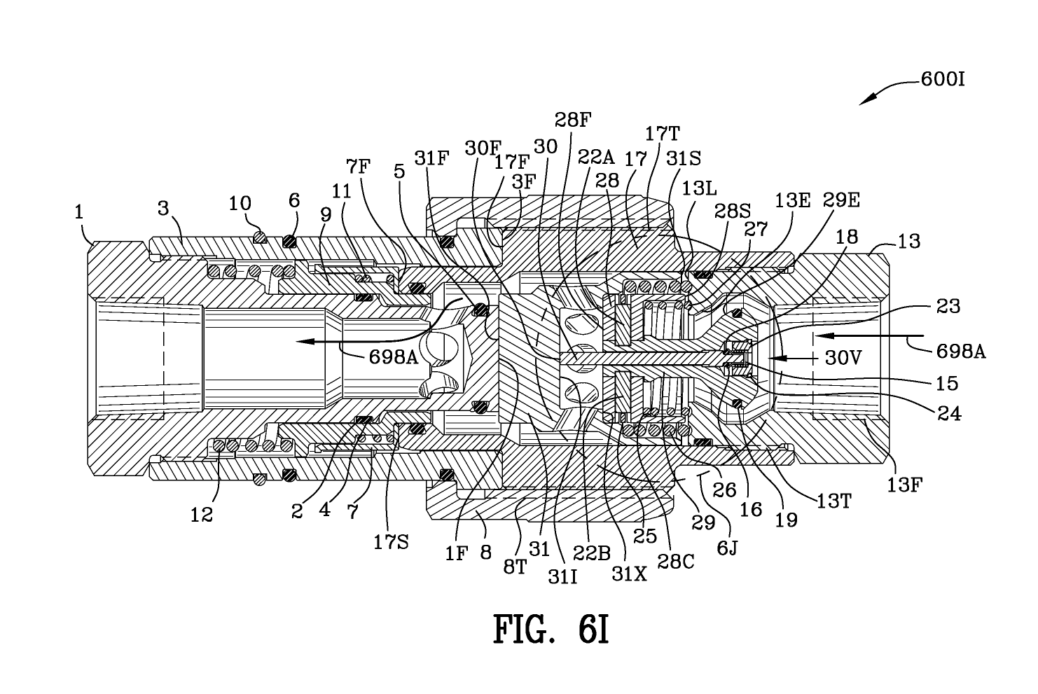

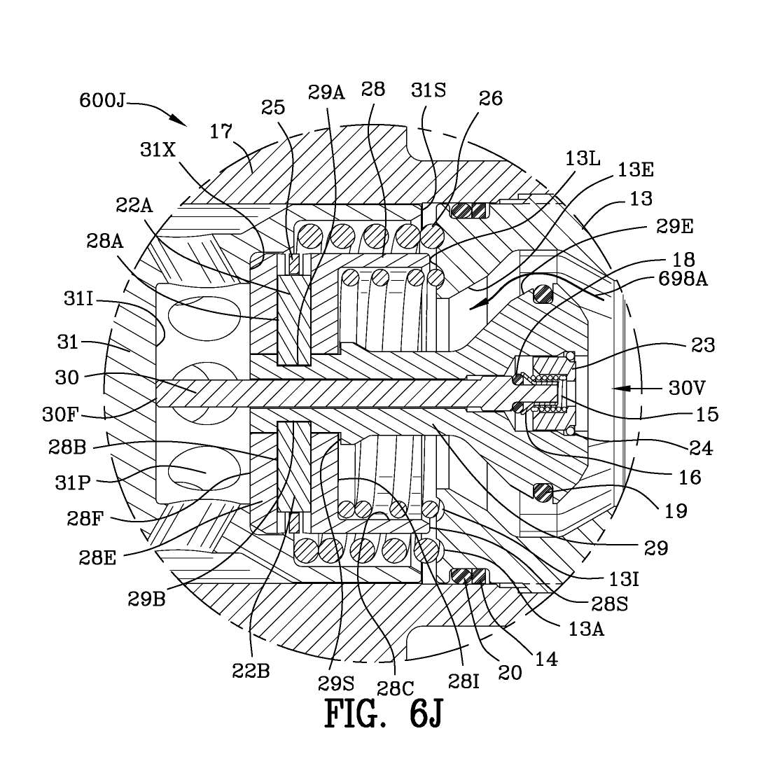

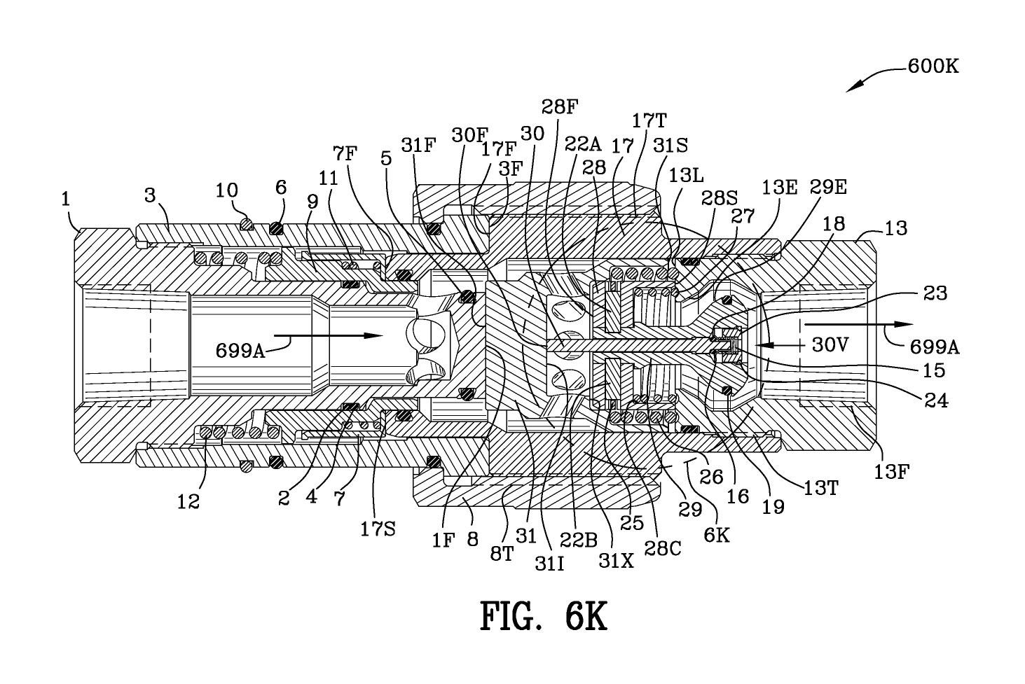

Referring to FIGS. 2A and 6H, secondary valve stop 28 includes a generally cylindrically shaped housing. FIG. 6H is a perspective view 600H of the secondary valve stop 28. The generally cylindrical housing 28 includes a cylindrical wall portion having an interior portion 28C and an exterior portion 28W. The generally cylindrical housing includes an end portion 28E thereof and a face 28F. In turn, the end portion 28E of the generally cylindrical housing includes a yoke portion 28Y. The yoke portion 28Y of the end portion 28E of the generally cylindrical housing includes a web having a cross-member 28M and a thicker portion integral with the generally cylindrical wall 28W of the housing. The yoke portion of the generally cylindrical housing includes an axial bore therethrough for receiving the cylindrical portion or stem of the secondary valve 29. The axial bore of the secondary valve stop 28 includes an inner diameter. The cross-member of the yoke includes first 28A and second 28B bores therein extending from the exterior portion 28W of the wall portion of the housing to the axial bore of the yoke portion 28Y of the generally cylindrical housing 28. The stem 29X of secondary valve is generally cylindrically shaped. The stem includes an outer diameter slightly smaller than the inner diameter of the axial bore 28X of the yoke portion 28Y of the generally cylindrical housing. First 22A and second 22B pins for axially securing the stem 29X with respect to the generally cylindrical housing are provided. The stem 29X includes a circumferential groove 29A therein for receiving the first 22A and second 22B pins extending through the first 28A and second 28B bores of the cross-member 28M of the yoke 28Y. A retaining member 25 for retaining the first and second pins 22A, 22B, respectively, in the first 28A and second 28B bores of the cross-member 28M of the yoke 28Y and also for retaining the first and second pins in the circumferential groove 29A of the stem 29X. The retaining member is a snap ring 25 and it may take any form. The snap-ring 25 shown herein is oriented vertically but there can be other orientations such as horizontal as illustrated in FIG. 2A. Still referring to FIG. 2A, reference numerals 14, 19, 20, and 21 all refer to seal members.

Still referring to FIG. 2A, main valve 31 is in its first, closed position and secondary valve 29 is illustrated in its first, closed position and secondary valve stop 28 is illustrated in its first position spaced apart from the main valve 31.

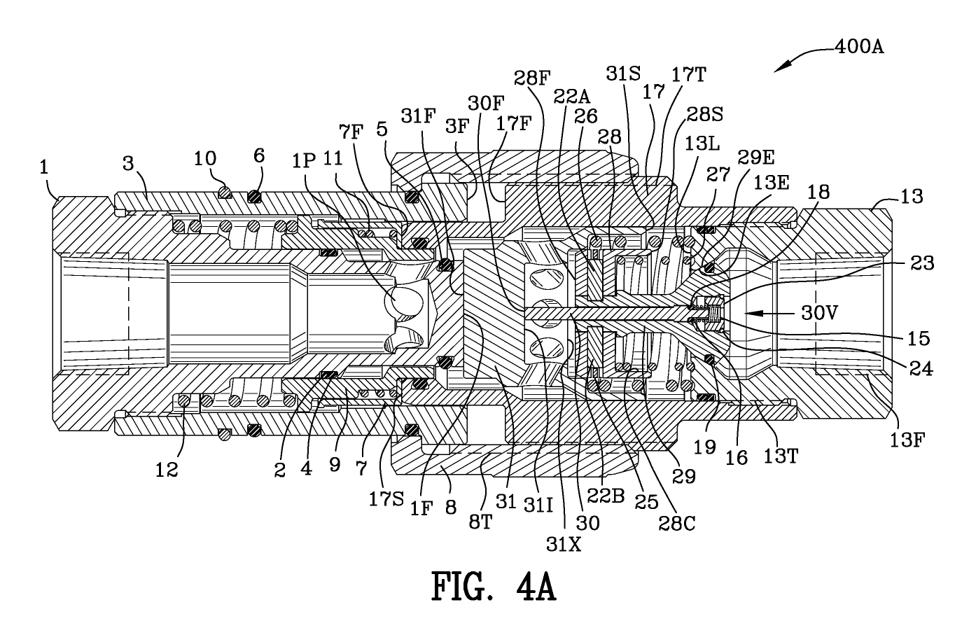

FIG. 3 is an elevation view 300 of the male and female halves of the coupling partially coupled wherein initial contact of the coupler and nipple half is occurring and the nipple valve is closed. FIG. 4 is an elevation view 400 of the male and female halves of the coupling partially coupled wherein the nipple valve 31 initially contacts the bleeder valve with the bleeder valve closed.

Referring to FIG. 3A, a cross-sectional view 300A of the male and female halves of the coupling illustrating initial contact of the coupler (female) and nipple (male) half while the nipple valve (main valve) 31 is closed, face IF of the female adaptor 1 is illustrated as just beginning engagement with the face 31F of the male coupling half. At this point in the coupling process, the main valve 31 of the male coupling half is not open and it is shown engaging body 17 of the male coupling half. FIG. 3A also illustrate sleeve 8 and internal threads 8T engaging male body 17 and external threads 17T. Still referring to FIG. 3A, the face 7F of retainer 7 is engaging face 17S of body 17 and sliding sleeve 9 is also engaging face 31F of main valve 31. Shoulders or faces 3F and 17F are illustrated as approaching each other as the coupling is in the process of being threaded together.

Still referring to FIG. 3A, the main valve 31 is in its first, closed position and the secondary valve 29 is illustrated in its first, closed position and the secondary valve stop 28 is indicated in its first position spaced apart from the main valve 31. Engagement surface 29E is illustrated engaging surface 13E of the adaptor.

FIG. 4A is a cross-sectional view 400A of the male and female halves of the coupling partially coupled illustrating an interior surface 31I of the nipple valve (main valve) 31 initially contacting the face 30F of bleeder valve 30 with the bleeder valve closed. Bleeder valve 30 has not yet moved rightwardly as illustrated in FIG. 4A. The bleeder valve assembly 30V is not, at this point of the coupling process, opened the bleeder valve to relieve pressure behind the secondary valve (to the right of the secondary valve when viewing FIG. 4A). As shown in FIG. 4A, the main valve 31 is not yet engaging the face 28F of the secondary valve stop 28. As illustrated in FIG. 4A, sleeve 8 has been threaded further onto male body 17 and faces 3F and 17F are getting closer to each other. In FIG. 4A, the main valve 31 has opened and is moving toward the secondary valve stop 28 and spring 26 operable between main valve 31 and adaptor 13 is in the process of being compressed. Referring to FIG. 4A, the secondary valve 29 is in its first, closed position and the secondary valve stop 28 is still in its first position.

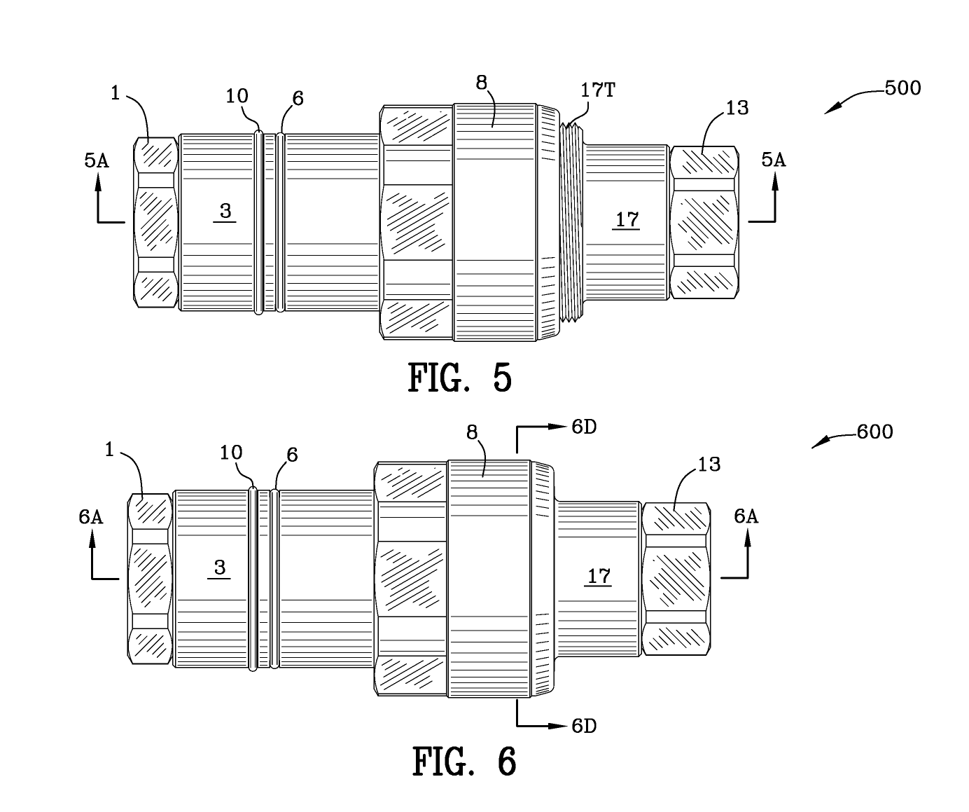

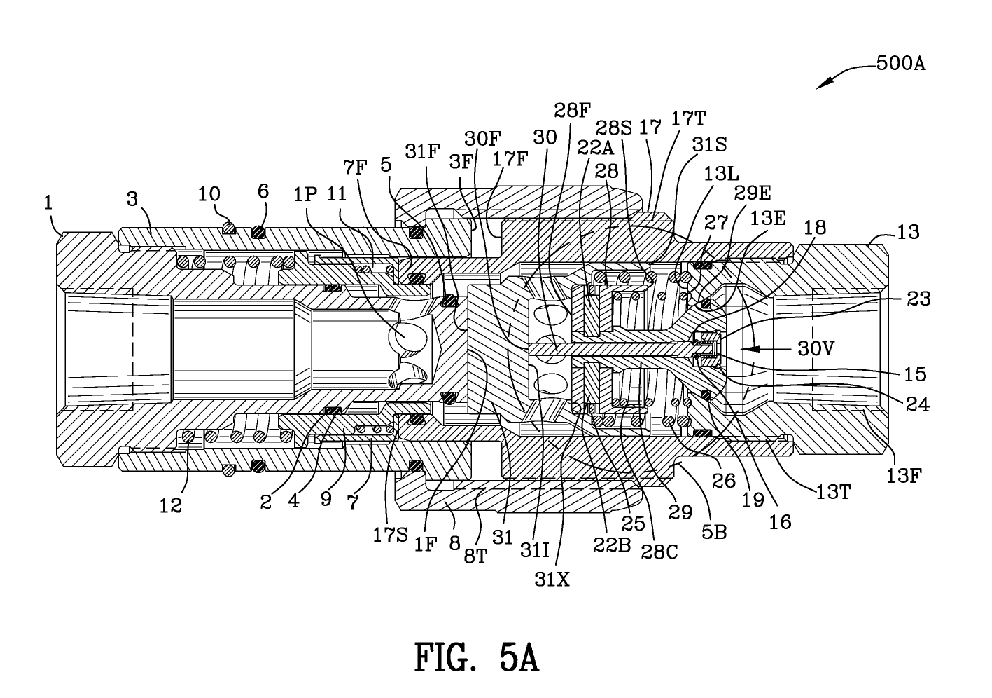

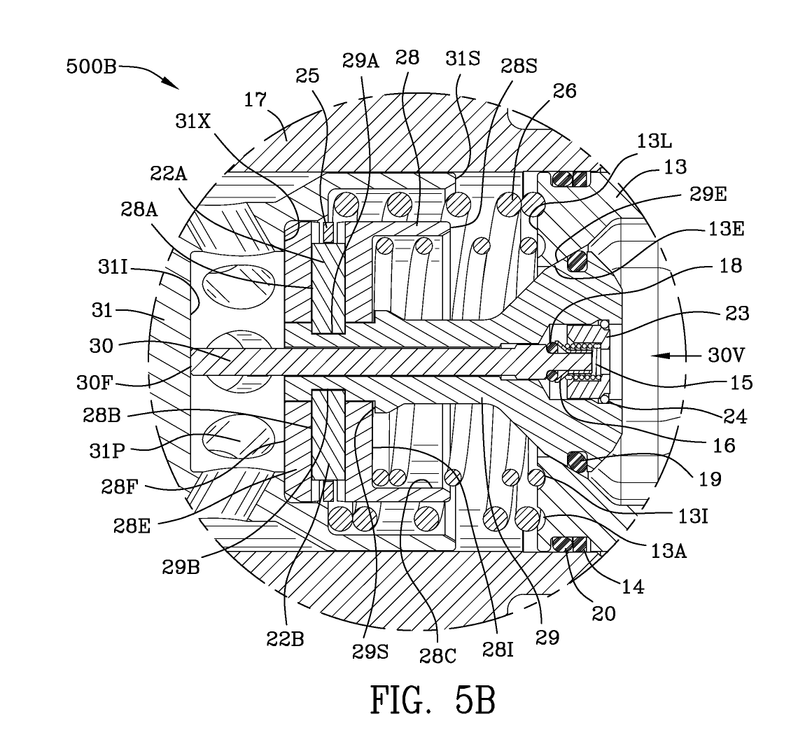

FIG. 5 is an elevation view 500 of the male and female halves of the coupling partially coupled wherein the bleeder valve 30 is open and the nipple valve (main valve) 31 and the secondary valve stop 28 are making initial contact. FIG. 5A is a cross-sectional view 500A of the male and female halves of the coupling partially coupled wherein the bleeder valve 30 is open and the nipple valve (main valve) 31 initially engages the secondary valve stop 28. FIG. 5B is enlargement 500B of a portion of FIG. 5A. Referring to FIGS. 5A and 5B, interior shoulder 31X of main valve 31 has just engaged face 28F of the secondary valve stop 28 and is not yet compressing spring 27 operable between interior surface 28I and adaptor 13 as the contact has just been made. FIG. 5B illustrates interior shoulder 31X of main valve 31, face 28F of the secondary valve stop 28, and interior surface 28I of the secondary valve stop very well. Interior surface 28I of secondary valve stop 28 is also illustrated in FIG. 6H.

FIG. 6 is an elevation view 600 of the coupler fully connected (coupled) with flow from the male half to the female half and wherein the nipple valve and the secondary valve stop are spaced apart from the nipple adaptor. FIG. 6A is a cross-sectional view of the first example of the coupler fully connected with no flow between the coupling halves or with flow from the male half to the female half and wherein the nipple valve (main valve) 31 and the secondary valve stop 28 are spaced apart from the nipple adaptor 13, 13L. Flow arrow 698 indicates fluid flow from the male coupling half to the female coupling half. Flow ports 1P of the female coupler and flow ports 31P of the male coupler are in fluidic communication as viewed in FIG. 6A.

FIGS. 6A and 6B represent a first example or embodiment where, when fully coupled, and without flow through the coupling, the secondary valve stop 28 does not extend rightwardly past the rightmost extent of the main valve 31. The examples or embodiments of the secondary stop valve 28 position with respect to the main valve 31 are defined without flow through the coupling. Therefore FIGS. 6A and 6B define the first example or embodiment wherein the secondary stop valve 28 does not extend rightwardly past the main valve 31 when fully coupled without flow through the coupling. FIGS. 6I and 6J represent a second example or embodiment where, when fully coupled, and without flow through the coupling, the secondary valve stop 28 extends rightwardly past the rightmost extent of the main valve 31.

In regard to the first example, the secondary valve stop 28 is illustrated in FIGS. 6A and 6B wherein face 28F of stop 28 abuts shoulder 31X of the main valve 31 and, engaging surface 28S is leftward of engaging surface 31S of the main valve. Engagement surface 28S does not extend past engaging surface 31S of main valve 31. FIG. 6B is an enlargement 600B of a portion of FIG. 6A and illustrates the main valve surface 31S and the secondary valve stop surface 28S well.

Still referring to FIGS. 6A and B, the secondary valve stop 28 does not extend past the main valve 31 rightwardly when fully coupled with no flow in the coupling. In this first example or embodiment, the positions of the respective components of the invention are dependent on the flow conditions within the coupling when fully coupled as will be discussed in connection with FIGS. 6A and 6F.

Referring to FIGS. 6A and 6B, the first flow condition is when there is no flow through the male and female coupling halves. Still referring to FIGS. 6A and 6B, the second flow condition is from the male coupling half to the female coupling half as indicated by flow arrow 698. Main valve 31 resides within the body 17 and is movable during coupling between: a first, closed position wherein the main valve engages the body as illustrated in FIGS. 2A and 3A; and a second, open position wherein the main valve 31 is spaced apart from the adaptor 13 when fully coupled as illustrated in FIG. 6A under the aforestated flow conditions (namely, no flow or flow from right to left). The secondary valve stop 28 is movable during coupling between a first position spaced apart from the main valve as illustrated in FIGS. 2A and 3A and a second position engaging the main valve 31 and spaced apart from the adaptor 13 when fully coupled as illustrated in FIG. 6A under the aforestated flow conditions. The secondary valve 29 is movable during coupling between: a first, closed position as illustrated in FIGS. 2A and 3A; and, a second, open position when fully coupled as illustrated in FIG. 6A under the aforestated flow conditions. In the second, open position the secondary valve is open and there is a large flow path between surfaces 13E of the adaptor and surfaces 29E of the secondary valve.

Secondary valve stop 28 protects spring 27 should the flow condition change to that depicted in FIG. 6F, namely from left to right. Similarly, main valve 31 protects spring 26 should the flow condition change to that of FIG. 6F.

FIG. 6C is an enlargement 600C of a portion of FIG. 6B illustrating a shoulder 501 on secondary valve 29 which engages shoulder 502 on bleeder valve 30 and limits the travel of the bleeder valve 30. A space/gap 30 for releasing pressure along the shaft of the bleeder valve from behind secondary valve 29 is illustrated in FIG. 6C. Reference numeral 23W represents a well in which spring 15 resides such that it is operable between retainer 23 and eyelet 16.

FIG. 6D is a cross-sectional view 600D taken along the lines 6D-6D of FIG. 6A. FIG. 6E is an enlargement 600E of a portion of FIG. 6D. FIG. 6D illustrates the circumferential groove 29A in secondary valve 29. Pins 22A, 22B are illustrated in groove 29A. FIG. 6H is a perspective view 600H of the secondary valve stop. Referring to FIGS. 6D, E and 6H, the yoke portion 28Y, the cross member 28M, and the axial bore 28X are illustrated along with the snap ring 25 in snap ring groove 28G.

FIGS. 6F and 6G represent the first example or embodiment under different flow conditions. The first example or embodiment is defined in connection with FIG. 6A where, when fully coupled, and without flow through the coupling, the secondary valve stop 28 does not extend rightwardly past the rightmost extent of the main valve 31. FIG. 6F has the same structure as FIG. 6A. FIG. 6F is a cross-sectional view 600F of the example of FIG. 6A with the coupling fully connected with flow from the female half to the male half as indicated by flow arrow 699 and with the nipple valve (main valve) 31 and the secondary valve stop 28 engaging the nipple adaptor. FIG. 6G is an enlargement 600G of a portion of FIG. 6F. In particular surface 31S of main valve 31 engages the adaptor 13, 13L as does surface 28S of secondary valve stop 28 under the flow as defined by flow arrow 699 from left to right (female to male). It will be noticed that a slight gap (unnumbered) is formed between the female adaptor face 1F and the face 31F of the main valve 31 by fluid flow 699 pushing against main valve 31. Further, it will be noticed that a slight gap (unnumbered) is also formed between shoulder 31X of the main valve 31 and face 28F of the secondary valve stop 28 by fluid flow 699 pushing against the secondary valve stop 28. FIG. 6G illustrates flow arrow 699 which results in pushing the secondary valve stop rightwardly into engagement with land 13L of the adaptor.

Still referring to FIGS. 6F and 6G, the secondary valve stop does not extend past the main valve when fully coupled with no flow in the coupling as stated above in connection with FIG. 6A. In this first embodiment, the positions of the respective components of the invention are dependent on the flow conditions within the coupling when fully coupled. FIGS. 6F and 6G illustrate the first example/embodiment when flow is from the female coupling half to the male coupling half. The flow condition within the coupling affects the position of the main valve 31, the secondary valve 29 and secondary valve stop 28. Main valve 31 resides within the body and is movable during coupling between: a first, closed position wherein the main valve engages the body as illustrated in FIGS. 2A and 3A; and, a third, open position wherein the main valve 31S engages the adaptor 13L when fully coupled under the aforestated flow conditions as illustrated in FIG. 6F. Secondary valve 29 as illustrated in FIG. 6F extends slightly further rightwardly and this position of the secondary valve is in the third, open position. Even though secondary valve 29 extends slightly further rightwardly as compared to its position illustrated in FIG. 6A, a wide, unimpeded flow path between the bulbous portion of secondary valve 29 and adaptor surface 13E is exhibited. As depicted in FIG. 6F, secondary valve stop 28 is movable during coupling between a first position spaced apart from the main valve as illustrated in FIGS. 2A and 3A and a third position spaced apart from the main valve 31X and engaging the adaptor land 13L when fully coupled under the aforestated flow conditions from the female coupler to the male coupler. Secondary valve 29 is movable during coupling between: a first, closed position as illustrated in FIGS. 2A and 3A; and, a third, open position when fully coupled under the aforestated flow conditions as illustrated in FIGS. 6F and 6G.

FIG. 6I is a cross-sectional view 600I of a second example of the coupler fully connected with no flow between the coupling halves or with flow from the male half to the female half and without the nipple valve (main valve) 31 and the secondary valve stop 28 engaging the nipple adaptor. FIG. 6J is a cross-sectional view 600J of a portion of FIG. 6I.

In the flow condition from the female coupling half to the male coupling half illustrated in FIGS. 6F and 6G, the secondary valve stop 28 protects spring 27 from compression and main valve 31 protects spring 26 from compression. Neither spring 27 nor spring 26 is compressed in FIGS. 6F or 6G as they are protected by secondary valve stop 28 and the main valve 31, respectively. Spring 27 operates between adaptor land 13L and surface 28I and is not compressed as the distance between the land 13L and the surface 28I as illustrated in FIG. 6G is large enough to prevent compression of spring 27. Spring 26 operates between land 13L and an unnumbered interior shoulder of main valve 31 and is not compressed as the distance between land 13L and the unnumbered surface as illustrated in FIG. 6G is large enough to prevent compression of spring 26. In the second example illustrated in FIGS. 6A, 6B, 6F and 6G, secondary valve stop member 28 and main valve 31 ensure that springs 27 and 26, respectively, are not compressed and can function properly and repetitively.

FIGS. 6I and 6J represent a second example or embodiment where, when fully coupled, and without flow through the coupling, the secondary valve stop 28 extends rightwardly past the rightmost extent of the main valve 31. The examples or embodiments of the secondary stop valve 28 position with respect to the main valve 31 are defined without flow through the coupling. Therefore FIGS. 6I and 6J define the second example or embodiment wherein the secondary stop valve 28 extends rightwardly past the main valve when fully coupled without flow through the coupling. FIGS. 6I and 6J represent a second example or embodiment where, when fully coupled, and without flow through the coupling, the secondary valve stop 28 extends rightwardly past the rightmost extent of the main valve 31.

In regard to the second example, the secondary valve stop 28 is illustrated in FIGS. 6I and 6J wherein face 28F of stop 28 abuts shoulder 31X of the main valve 31 and, engaging surface 28S is rightward of engaging surface 31S of the main valve. Engagement surface 28S extends past engaging surface 31S of main valve 31. FIG. 6J is an enlargement 600J of a portion of FIG. 6I and illustrates the main valve surface 31S and the secondary valve stop surface 28S well.

Still referring to FIGS. 6I and 6J, the secondary valve stop 28 extends past main valve 31 rightwardly when fully coupled with no flow in the coupling. In this second example or embodiment, the positions of the respective components of the invention are dependent on the flow conditions within the coupling when fully coupled as will be discussed in connection with FIGS. 6I and 6K. Referring to FIGS. 6I and 6J, the first flow condition is when there is no flow through the male and female coupling halves. Still referring to FIGS. 6I and 6J, the second flow condition is from the male coupling half to the female coupling half as indicated by flow arrow 698A. Main valve 31 resides within the body 17 and is movable during coupling between: a first, closed position wherein the main valve engages the body as illustrated in FIGS. 2A and 3A; and a second, open position wherein the main valve 31 is spaced apart from the adaptor 13 when fully coupled as illustrated in FIG. 6I under the aforestated flow conditions (namely, no flow or flow from right to left). The secondary valve stop 28 is movable during coupling between a first position spaced apart from the main valve as illustrated in FIGS. 2A and 3A and a second position engaging the main valve 31 and spaced apart from the adaptor 13 when fully coupled as illustrated in FIGS. 6I and 6J under the aforestated flow conditions. The secondary valve 29 is movable during coupling between: a first, closed position as illustrated in FIGS. 2A and 3A; and, a second, open position when fully coupled as illustrated in FIGS. 6I and 6J under the aforestated flow conditions.

FIGS. 6K and 6L represent the second example or embodiment under different flow conditions. The second example or embodiment is defined in connection with FIG. 6I where, when fully coupled, and without flow through the coupling, the secondary valve stop 28 extends rightwardly past the rightmost extent of the main valve 31. FIG. 6K has the same structure as FIG. 6I. FIG. 6K is a cross-sectional view 600K of the example of FIG. 6I with the coupling fully connected with flow from the female half to the male half as indicated by flow arrow 699A and with the nipple valve (main valve) 31 spaced apart from the adaptor and the secondary valve stop 28 engaging the nipple adaptor. FIG. 6L is an enlargement 600L of a portion of FIG. 6K. In particular surface 31S of main valve 31 is spaced apart from adaptor 13, 13L and surface 28S of secondary valve stop 28 engages adaptor land 13L under the flow as defined by flow arrow 699A from left to right (female to male). It will be noticed that a slight gap (unnumbered) is formed between shoulder 31X of the main valve 31 and face 28F of the secondary valve stop 28 by fluid flow 699A pushing against the secondary valve stop 28. FIG. 6L illustrates flow arrow 699A which results in pushing the secondary valve stop 28 rightwardly into engagement with land 13L of the adaptor.

Still referring to FIGS. 6K and 6L, the secondary valve stop 28 extends past main valve 31 when fully coupled with no flow in the coupling as stated above in connection with FIG. 6I. In this second example or embodiment, the positions of the respective components of the male coupling half are dependent on the flow conditions within the coupling when fully coupled. FIGS. 6K and 6L illustrate the second example/embodiment when flow is from the female coupling half to the male coupling half. The flow condition within the coupling affects the position of the main valve 31, the secondary valve 29 and secondary valve stop 28. Main valve 31 resides within the body and is movable during coupling between: a first, closed position wherein the main valve engages the body as illustrated in FIGS. 2A and 3A; and, a second, open position wherein the main valve 31S is spaced apart from the adaptor 13L when fully coupled under the aforestated flow conditions as illustrated in FIG. 6K. Secondary valve 29 as illustrated in FIG. 6K extends slightly further rightwardly and this position of the secondary valve is in the third, open position. Even though secondary valve 29 extends slightly further rightwardly as compared to its position illustrated in FIG. 6I, a wide, unimpeded flow path between the bulbous portion of secondary valve 29 and adaptor surface 13E is exhibited. As depicted in FIG. 6K, secondary valve stop 28 is movable during coupling between a first position spaced apart from the main valve as illustrated in FIGS. 2A and 3A and a third position spaced apart from the main valve 31X and engaging the adaptor land 13L when fully coupled under the aforestated flow conditions from the female coupler to the male coupler. Secondary valve 29 is movable during coupling between: a first, closed position as illustrated in FIGS. 2A and 3A; and, a third, open position when fully coupled under the aforestated flow conditions as illustrated in FIGS. 6K and 6L.

In the flow condition from the female coupling half to the male coupling half illustrated in FIGS. 6K and 6L, the secondary valve stop 28 protects spring 27 from compression. In FIG. 6K, main valve 31 is illustrated as being separated from adaptor 13 with spring 26 not compressed. Main valve 31 does not engage the adaptor 13 and will not engage the adaptor even if large flow is present in the coupler. Neither spring 27 nor spring 26 is compressed in FIG. 6K or 6L. Spring 27 operates between adaptor land 13L and surface 28I and is not compressed as the distance between the land 13L and the surface 28I as illustrated in FIG. 6L is large enough to prevent compression of spring 27. Spring 26 operates between land 13L and an unnumbered interior shoulder of main valve 31 and is not compressed. In the second example illustrated in FIGS. 6I, 6J, 6K and 6L, secondary valve stop member 28 prevents main valve from engaging adaptor 13 which ensures that spring 26 is not compressed and can function properly and repetitively.

FIG. 7 is an elevation view 700 of the secondary valve stop 28, the secondary valve 29 and the bleeder stem. Snap ring 25 resides in snap ring groove 28G. Snap ring 25 resides in groove 28G and maintains pins 22A, 22B in bores 28A, 28B of the secondary valve stop 28. Bleeder valve 30 and face 30F of bleeder valve 30 are illustrated in FIG. 7 as is the secondary valve 29. Surface 29E is depicted in FIG. 7 and engages adaptor 13 as illustrated in, for example, FIG. 6A. FIG. 7 is a good illustration of the bulbous part of the secondary valve.

FIG. 7A is an exploded view 700A of the secondary valve stop 28, the secondary valve 29, the bleeder stem 30, the bleeder and the valve arrangement comprised of seal 18, eyelet 16, spring 15, retainer 23 and snap ring 24 which retains the valve arrangement in secondary valve 29. Circumferential groove 29A and shoulder 29S are illustrated in FIG. 7A. The secondary valve stop 28 is sometimes referred to herein as a coupling stem support member.

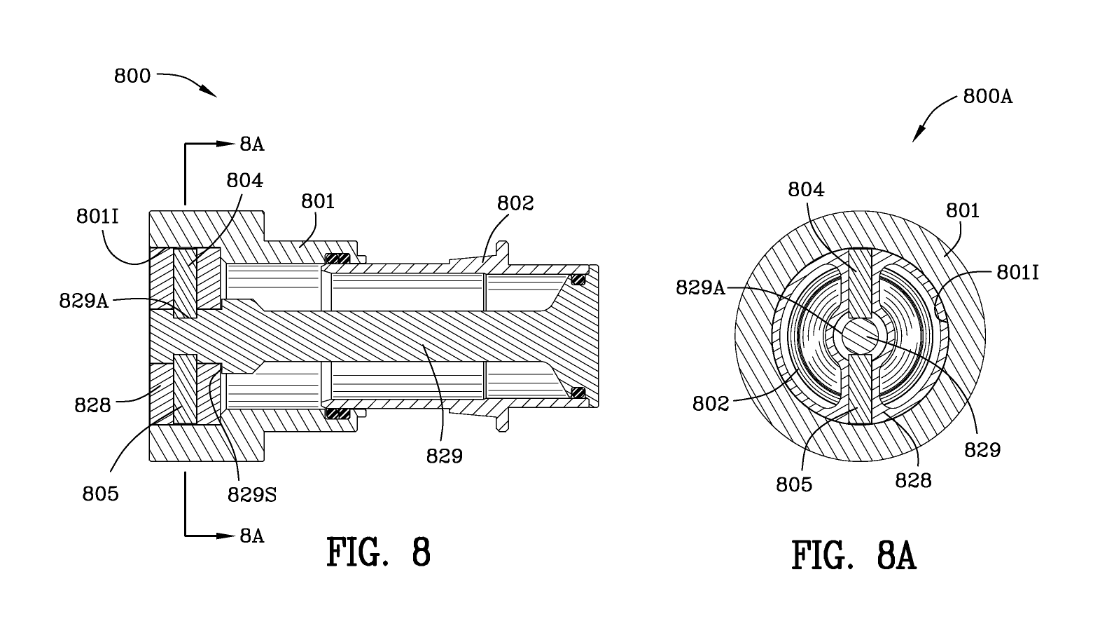

FIG. 8 is a cross-sectional view 800 of a second embodiment of a valve stop 828 without a snap ring. FIG. 8A is a cross-sectional view 800A taken along the lines 8A-8A of FIG. 8. Stem or secondary valve 829 includes a shoulder 829S which interengages valve stop 828. A circumferential groove 829A receives pins 804, 805 and in this example, the pins are restrained by the inner surface 801I of body 801. Body part 802 serves to support stem 829.

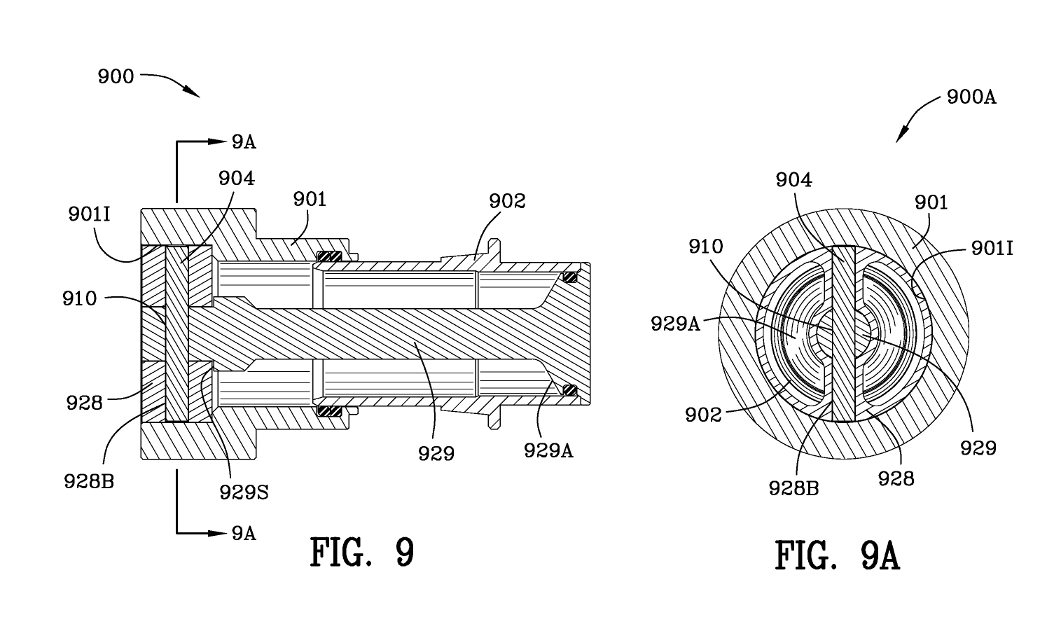

FIG. 9 is a cross-sectional view 900 of a third embodiment of a valve stop 928 without a snap ring and with a pin 904 extending through valve stop 928 and through secondary valve or stem 929. Secondary valve or stem 929 includes a shoulder 929S thereon which interengages and supports valve stop 928. Bore 928B extends through valve stop 928 and bore 910 extends through stem 929. Body 901 supports valve stop 928 and inner surface 901I restrains pin 904 within valve stop 928. Stem 929 or secondary valve 929 includes a bulbous portion viewed in FIGS. 9 and 9A. FIG. 9A is a cross-sectional view 900A taken along the liens 9A-9A of FIG. 9.

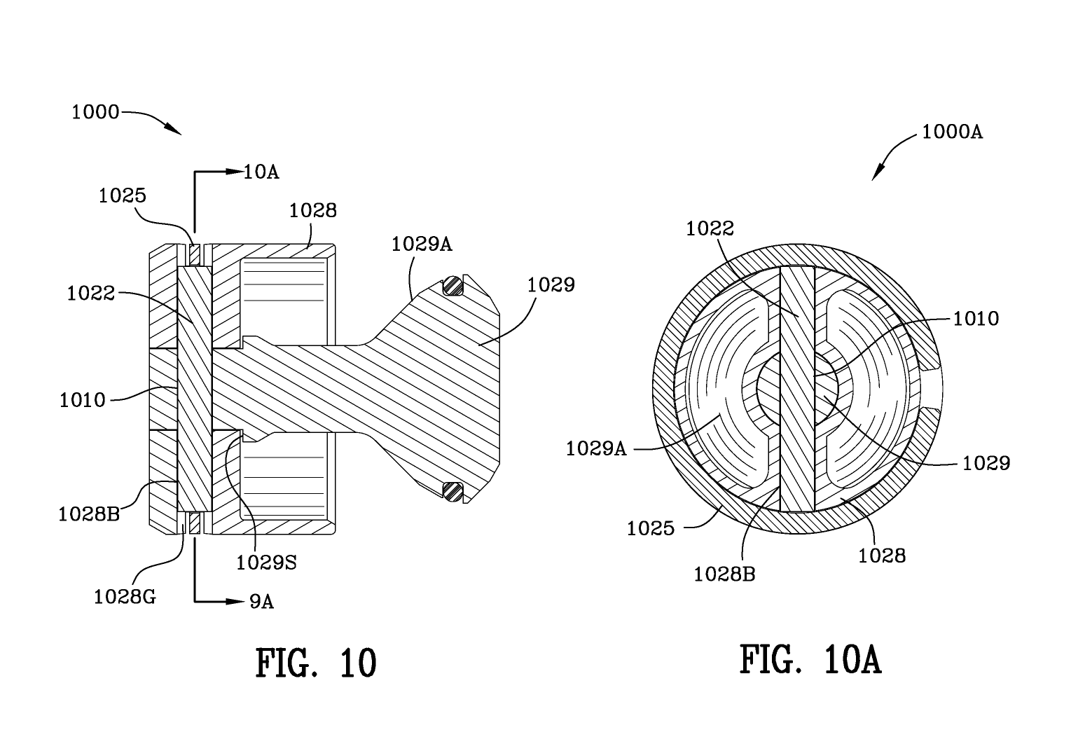

FIG. 10 is a cross-sectional view 1000 of a fourth embodiment of a valve stop 1028 with a snap ring 1025 and a pin 1022 that extends through valve stop 1028 and the secondary valve 1029. FIG. 10A is a cross-sectional view 1000A taken along the lines 10A-10A of FIG. 10. Bore 1028B extends through valve stop 1028 and bore 1010 extends through stem or secondary valve 1029. Bulbous portion 1029A of the stem or secondary valve is illustrated in FIGS. 10 and 10A. Snap ring 1025 resides in snap ring groove 1028G. Shoulder 1029S also restrains valve stop 1028 from axial movement.

### REFERENCE NUMERALS

100—front elevation view female coupling half
100A—cross-sectional view of the female coupling half taken along the lines 1A-1A of FIG. 1
1—female adaptor
1F—face of adaptor 1
1P—ports in adaptor of female
2—back up ring
3—female body threaded to female adaptor 1
3F—face of body 3
4—O-ring
5—O-ring
6—seal
7—retainer
7F—face of retainer
8—sleeve with threaded interior
8T—threaded interior of sleeve 8
9—sliding sleeve
10—snap ring
11—spring operable between sliding sleeve and retainer
12—spring operable between adaptor and sliding sleeve
13—adaptor 13 of male coupling half
13A—outer spring groove for seating spring 26
13I—inner spring groove for seating spring 27
13E—adaptor surface
13F—interior threads on male adaptor 13
13L—land on adaptor 13
13T—threads on adaptor 13
14—seal
15—bleeder valve spring 15
16—brass eyelet
17—body
17F—shoulder which engages face 3F of coupler body 3
17S—front surface of nipple valve
17T—external threads
18, 19—seal
20—back up seal
21—seal
22A, 22B—pins securing valve stop 28 from lateral movement with respect to secondary valve 29
23—retainer
23W—retainer well
24—snap ring
25—snap-ring
26—nipple valve spring
27—valve stop spring
28—secondary valve stop with cylindrically extending portion
28A—bore in secondary valve stop 28
28B—bore in secondary valve stop 28
28C—interior cylindrically extending portion of secondary valve stop 28
28E—end portion of secondary valve stop 28
28F—face of secondary valve stop 28
28I—interior portion of secondary valve stop 28
28M—cross member of yoke
28P—flow ports in secondary valve stop 28
28S—engaging surface of secondary valve stop which interengages land 13L on adaptor 13 under certain conditions
28W—exterior cylindrically extending wall portion of secondary valve stop
28X—axial bore for receiving stem/cylindrical portion of secondary valve 29
28Y—yoke portion of secondary valve stop
29—secondary valve
29A—circumferential groove in secondary valve 29
29E—secondary valve surface which engages adaptor surface 13E
29N, 29Z—slots in another example of secondary valve 29 for interengagement with pins 22A, 22B
29S—shoulder on secondary valve 29
29X—cylindrical stem portion of secondary valve 29
30—bleeder valve
30E—face of bleeder valve whish engages interior 31I of nipple valve 31
30V—bleeder valve assembly
31—nipple valve (main valve)
31I—interior of nipple valve which engages bleeder valve face 30
31F—nipple valve face
31P—ports in nipple valve 31
31S—surface of nipple valve 31 which may engage adaptor 13
31X—shoulder on nipple valve 31 which engages 28F
200—elevation view male coupling half
200A—cross-sectional view of the male coupling half taken along the lines 2A-2A of FIG. 1
300—elevation view of the male and female halves of the coupling partially coupled wherein initial contact of the coupler and nipple half is occurring and the nipple valve is closed
300A—cross-sectional view of the male and female halves of the coupling illustrating initial contact of the coupler and nipple half while the nipple valve is closed
400—elevation view of the male and female halves of the coupling partially coupled wherein the nipple valve 31 initially contacts the bleeder valve with the bleeder valve closed
400A—cross-sectional view of the male and female halves of the coupling partially coupled illustrating the nipple valve 31 initially contacting the bleeder valve 30 with the bleeder valve closed
500—elevational view of the male and female halves of the coupling partially coupled wherein the bleeder valve is open and the nipple valve and the valve stop are making initial contact
500A—cross-sectional view of the male and female halves of the coupling partially coupled wherein the bleeder valve is open and the nipple valve initially engages the valve stop
500B—enlargement of a portion of FIG. 5A
501—shoulder on secondary valve 29 which engages shoulder 502 on bleeder valve 30
502—shoulder on bleeder valve 30
503—space/gap for releasing pressure behind secondary valve 29
600—elevation view of the coupler fully connected with flow from the male half to the female half and without the nipple view and the valve stop engaging the nipple adaptor;
600A—cross-sectional view of the coupler fully connected with flow from the male half to the female half and without the nipple valve and the valve stop engaging the nipple adaptor
600B—an enlargement of a portion of FIG. 6A
600C—an enlargement of a portion of FIG. 6B
600D—a cross-sectional view taken along the lines 6D-6D of FIG. 6A
600E—an enlargement of a portion of FIG. 6D
600F—a perspective view of the valve stop
600G—cross-sectional view of the coupler fully connected with flow from the female half to the male half and with the nipple valve and the valve stop engaging the nipple adaptor
600H—a perspective view of the secondary valve stop
600I—a cross-sectional view of a second example of the coupler fully connected with no flow between the coupling halves or with flow from the male half to the female half and without the nipple valve (main valve) and the secondary valve stop engaging the nipple adaptor.
600J—a cross-sectional view of a portion of FIG. 6I
600K—a cross-sectional view of a second example of the coupler fully connected with flow from the female half to the male half and with the nipple valve (main valve) and the secondary valve stop engaging the nipple adaptor
600L—an enlargement of a portion of FIG. 6K
698—flow arrow indicating flow from the male coupling half to the female coupling half in FIG. 6A
698A—flow arrow indicating flow from the male coupling half to the female coupling half in FIG. 6I
699—flow arrow indicating flow from the female coupling half to the male coupling half in FIG. 6F
699A—flow arrow indicating from the female coupling half to the male coupling half in FIG. 6K
700—an elevation view of the valve stop, the secondary valve and the bleeder stem
700A—an exploded view of the valve stop, the secondary valve, the bleeder stem, the bleeder and the valve arrangement
700B—illustration of slots 29N and 29Z in another example of the secondary valve.
701—snap ring groove in valve stop 28
800—a cross-sectional view of a second embodiment of a valve stop without a snap ring
800A—a cross-sectional view taken along the lines 8A-8A of FIG. 8
801—body of second embodiment
801I—interior of body
802—second body portion
804, 805—pins
828—valve stop of second embodiment
829—secondary valve
829A—circumferential groove in secondary valve 803
829S—shoulder on secondary valve 829
900—a cross-sectional view of a third embodiment of a valve stop without a snap ring and with a pin extending through the valve stop and through the secondary valve
900A—a cross-sectional view taken along the liens 9A-9A of FIG. 9
901—body of third embodiment
901I—interior of body 901
902—second body portion
904—pin
906—valve stop
910 bore through secondary valve 929
928—valve stop of third embodiment
928B—bore through valve stop 928 for receiving pin 904
929—secondary valve
929A—sloped surface on secondary valve 929
929S—shoulder on secondary valve 929
1000—a cross-sectional view of a fourth embodiment of a valve stop with a snap ring and a pin that extends through the valve stop and the secondary valve 1003
1000A—a cross-sectional view taken along the lines 10A-10A of FIG. 10
1022—pin
1025—snap ring
1028—valve stop fourth embodiment
1028B—bore through valve stop 1028 for receiving pin 1022
1029—secondary valve
1029A—sloped surface on secondary valve 1029
1028G—snap ring groove
1029S—shoulder

The invention has been set forth by way of example only. Those skilled in the art will readily recognize that changes may be made to the invention as set forth without departing from the spirit and the scope of the claims as set forth hereinbelow.

1. A male coupling half, comprising:
a body:
an adaptor;
a main valve;
a secondary valve;
a secondary
valve stop, said secondary valve stop affixed to said secondary valve, and, said secondary valve stop resides intermediate said main valve and said adaptor;
first and second pins;
said secondary valve stop includes first and second pin holes;
said first and second pins residing in said first and second pin holes of said secondary valve stop; and,
said main valve in combination with said secondary valve stop limiting movement of said secondary valve preventing over travel of said secondary valve.

2. A male coupling half as claimed in claim 1, wherein:
said secondary valve stop is generally cylindrically shaped, and, said generally cylindrically shaped secondary valve stop includes an end portion having a yoke;
said secondary valve includes a shoulder thereon and a circumferential groove therein;
said yoke portion abuts said shoulder of said secondary valve;
said yoke portion of said secondary valve stop includes said first and second pin holes therein;
said first and second pins extend through said first and second pin holes in said yoke and interengage said circumferential groove of said secondary valve stop;
said secondary valve stop further includes a snap ring groove, and, said snap ring groove traverses said first and second pin holes;
a snap ring;
said snap ring residing in said snap ring groove retaining said first and second pins; and,
said secondary valve stop being capable of rotation about said secondary valve.

3. A male coupling half as claimed in claim 1, wherein:
said secondary valve stop includes an engagement surface, said engagement surface abutting said adaptor preventing over travel of said secondary valve.

4. A male coupling half as claimed in claim 1, wherein:
said main valve resides within said body and is movable between: a first, closed position wherein said main valve engages said body; and a second, open position wherein said main valve is spaced apart from said adaptor; and a third, open position wherein said main valve engages said adaptor;
said secondary valve movable between: a first, closed position; and second, open position; and a third, open position; and,
said secondary valve stop movable between a first position spaced apart from said main valve, a second position engaging said main valve and spaced apart from said adaptor, and a third position engaging said main valve and said adaptor.

5. A male coupling half as claimed in claim 1, wherein:
said main valve resides within said body and is movable between: a first, closed position wherein said main valve engages said body; and a second, open position wherein said main valve is spaced apart from said adaptor;
said secondary valve stop is movable between a first position spaced apart from said main valve and a second position engaging said main valve and spaced apart from said adaptor;
said secondary valve is movable between: a first, closed position; and, a second, open position.

6. A male coupling half as claimed in claim 1, wherein:
said main valve resides within said body and is movable between: a first, closed position wherein said main valve engages said body; and, a third, open position wherein said main valve engages said adaptor;
said secondary valve stop movable between a first position spaced apart from said main valve and a third position spaced apart from said main valve and engaging said adaptor; and,
said secondary valve is movable between: a first, closed position; and, a third, open position.

7. A male coupling half as claimed in claim 1, wherein:
said main valve resides within said body and is movable between: a first, closed position wherein said main valve engages said body; and a second, open position wherein said main valve is spaced apart from said adaptor;
said secondary valve stop movable between a first position spaced apart from said main valve and a second position engaging said main valve and said adaptor; and,
said secondary valve is movable between: a first, closed position; and, a second, open position.

8. A male coupling half as claimed in claim 1, wherein:
said main valve resides within said body and is movable between: a first, closed position wherein said main valve engages said body; and a second, open position wherein said main valve is spaced apart from said adaptor;
said secondary valve stop movable between a first position spaced apart from said main valve and a second position spaced apart from said main valve and engaging said adaptor; and,
said secondary valve is movable between: a first, closed position; and, a third, open position.

9. A male coupling half coupled with a female coupling half, said male half comprising:
a body:
an adaptor;
a main valve;
a secondary valve;
a secondary valve stop, said secondary valve stop affixed to said secondary valve, and, said secondary valve stop resides intermediate said main valve and said adaptor;
first and second pins;
said secondary valve stop includes first and second pin holes;
said first and second pins residing in said first and second pin holes of said secondary valve stop; and,
said main valve in combination with said secondary valve stop limiting movement of said secondary valve preventing over travel of said secondary valve.

10. A male coupling half coupled with a female coupling half as claimed in claim 9, wherein said male half further includes:
said secondary valve stop is generally cylindrically shaped, and, said generally cylindrically shaped secondary valve stop includes an end portion having a yoke;
said secondary valve includes a shoulder thereon and a circumferential groove therein;
said yoke portion abuts said shoulder of said secondary valve;
said yoke portion of said secondary valve stop includes said first and second pin holes therein;
said first and second pins extend through said first and second pin holes in said yoke and interengage said circumferential groove of said secondary valve stop;
said secondary valve stop further includes a snap ring groove, and, said snap ring groove traverses said first and second pin holes;
a snap ring;
said snap ring residing in said snap ring groove retaining said first and second pins; and,
said secondary valve stop being capable or rotation about said secondary valve.

11. A male coupling half coupled with a female coupling half as claimed in claim 9, wherein said male half further includes:
said secondary valve stop includes an engagement surface, said engagement surface abutting said adaptor preventing over travel of said secondary valve.

12. A male coupling half coupled with a female coupling half as claimed in claim 9, wherein said male half further includes:
said main valve resides within said body and is movable between: a first, closed position wherein said main valve engages said body; and a second, open position wherein said main valve is spaced apart from said adaptor; and a third, open position wherein said main valve engages said adaptor;
said secondary valve movable between: a first, closed position; and second, open position; and a third, open position; and,
said secondary valve stop movable between a first position spaced apart from said main valve, a second position engaging said main valve and spaced apart from said adaptor, and a third position engaging said main valve and said adaptor.

13. A male coupling half coupled with a female coupling half as claimed in claim 9, wherein said male half further includes:
said main valve resides within said body and is movable during coupling between: a first, closed position wherein said main valve engages said body; and a second, open position wherein said main valve is spaced apart from said adaptor;
said secondary valve stop movable during coupling between a first position spaced apart from said main valve and a second position engaging said main valve and spaced apart from said adaptor;
said secondary valve movable during coupling between: a first, closed position; and, a second, open position.

14. A male coupling half coupled with a female coupling half as claimed in claim 9, wherein said male half further includes:
said main valve resides within said body and is movable during coupling between: a first, closed position wherein said main valve engages said body; and, a third, open position wherein said main valve engages said adaptor;
said secondary valve stop is movable during coupling between a first position spaced apart from said main valve and a third position spaced apart from said main valve and engaging said adaptor; and,
said secondary valve is movable during coupling between: a first, closed position; and, a third, open position.

15. A male coupling half coupled with a female coupling half as claimed in claim 9, wherein said male half further includes:
said main valve resides within said body and is movable during coupling between: a first, closed position wherein said main valve engages said body; and a second, open position wherein said main valve is spaced apart from said adaptor;
said secondary valve stop movable during coupling between a first position spaced apart from said main valve and a second position engaging said main valve and spaced apart from said adaptor; and,
said secondary valve is movable during coupling between: a first, closed position; and, a second, open position.

16. A male coupling half coupled with a female half as claimed in claim 9, wherein:
said main valve resides within said body and is movable during coupling between: a first, closed position wherein said main valve engages said body; and a second, open position wherein said main valve is spaced apart from said adaptor;
said secondary valve stop movable during coupling between a first position spaced apart from said main valve and a second position spaced apart from said main valve and engaging said adaptor; and,
said secondary valve is movable during coupling between: a first, closed position; and, a third, open position.

17. A coupling stem support member in combination with a stem, comprising:
a generally cylindrical housing;
said generally cylindrical housing includes a cylindrical wall portion having an interior portion and an exterior portion;
said generally cylindrical housing includes an end portion thereof;
said end portion of said generally cylindrical housing includes a yoke portion;
said yoke portion of said end portion of said generally cylindrical housing includes a web having a cross-member and a thicker portion integral with said generally cylindrical wall of said housing;
said yoke portion of said generally cylindrical housing includes an axial bore therethrough for receiving said stem, said axial bore includes an inner diameter;
said cross-member of said yoke includes first and second bores therein extending from said exterior portion of said wall portion of said housing to said axial bore of said yoke portion of said generally cylindrical housing;
said stem being generally cylindrically shaped, said stem includes an outer diameter slightly smaller than said inner diameter of said axial bore of said yoke portion of said generally cylindrical housing;
first and second pins for axially securing said stem with respect to said generally cylindrical housing;
said stem includes a circumferential groove therein for receiving said first and second pins extending through said first and second bores of said cross-member of said yoke; and,
a retaining member for retaining said first and second pins, respectively, in said first and second bores of said cross-member of said yoke and also for retaining said first and second pins in said circumferential groove of said stem.

18. A coupling support member in combination with a stem as claimed in claim 17 wherein said retaining member is a snap ring.

19. A coupling stem support member in combination with a stem as claimed in claim 18 wherein said yoke portion of said generally cylindrical housing includes flow ports therein enabling fluid communication through said support member.

20. A coupling stem support member in combination with a stem as claimed in claim 19 wherein:
said generally cylindrical housing includes a second end portion thereof terminating in a surface, said surface designed to engage another portion of said coupling; and,
said stem includes a shoulder thereon which abuts said web portion of said yoke portion of said generally cylindrical housing.

21. A coupling stem support member in combination with a stem, comprising:
a generally cylindrical housing;
said generally cylindrical housing includes a cylindrical wall portion having an interior portion and an exterior portion;
said generally cylindrical housing includes an end portion thereof;
said end portion of said generally cylindrical housing includes a yoke portion;
said yoke portion of said end portion of said generally cylindrical housing includes a web having a cross-member;
said yoke portion of said generally cylindrical housing includes an axial bore therethrough for receiving said stem, said axial bore includes an inner diameter;
said cross-member of said yoke includes first and second bores therein extending from said exterior portion of said wall portion of said housing to said axial bore of said yoke portion of said generally cylindrical housing;
said stem being generally cylindrically shaped, said stem includes an outer diameter slightly smaller than said inner diameter of said axial bore of said yoke portion of said generally cylindrical housing;
a pin for axially securing said stem with respect to said generally cylindrical housing;
said stem includes a bore therethrough for receiving said pin extending through said first and second bores of said cross-member of said yoke; and,
a retaining member for retaining said pin in said first and second bores of said cross-member of said yoke.

22. A male coupling half as claimed in claim 1, wherein:
said secondary valve stop is generally cylindrically shaped, and, said generally cylindrically shaped secondary valve stop includes an end portion having a yoke;
said secondary valve includes first and second slots therein;
said yoke portion of said secondary valve stop includes said first and second pin holes therein;
said first and second pins extend through said first and second pin holes in said yoke and interengage said slots of said secondary valve stop;
said secondary valve stop further includes a snap ring groove, and, said snap ring groove traverses said first and second pin holes;
a snap ring; and,
said snap ring residing in said snap ring groove retaining said first and second pins.

23. A male coupling half coupled with a female coupling half as claimed in claim 9, wherein said male half further includes:
said secondary valve stop is generally cylindrically shaped, and, said generally cylindrically shaped secondary valve stop includes an end portion having a yoke;
said secondary valve includes first and second slots therein;
said yoke portion of said secondary valve stop includes said first and second pin holes therein;
said first and second pins extend through said first and second pin holes in said yoke and interengage said slots of said secondary valve stop;
said secondary valve stop further includes a snap ring groove, and, said snap ring groove traverses said first and second pin holes;
a snap ring; and,
said snap ring residing in said snap ring groove retaining said first and second pins.

24. A coupling stem support member in combination with a stem, comprising:
a generally cylindrical housing;
said generally cylindrical housing includes a cylindrical wall portion having an interior portion and an exterior portion;
said generally cylindrical housing includes an end portion thereof;
said end portion of said generally cylindrical housing includes a yoke portion;
said yoke portion of said end portion of said generally cylindrical housing includes a web having a cross-member and a thicker portion integral with said generally cylindrical wall of said housing;
said yoke portion of said generally cylindrical housing includes an axial bore therethrough for receiving said stem, said axial bore includes an inner diameter;
said cross-member of said yoke includes first and second bores therein extending from said exterior portion of said wall portion of said housing to said axial bore of said yoke portion of said generally cylindrical housing;
said stem being generally cylindrically shaped, said stem includes an outer diameter slightly smaller than said inner diameter of said axial bore of said yoke portion of said generally cylindrical housing;
first and second pins for axially securing said stem with respect to said generally cylindrical housing;
said stem includes first and second exterior slots therein for receiving said first and second pins extending through said first and second bores of said cross-member of said yoke; and,
a retaining member for retaining said first and second pins, respectively, in said first and second bores of said cross-member of said yoke and also for retaining said first and second pins in said first and second slots of said stem.
